(19) United States
(12) Patent Application Publication
(10) Pub. No.: US 2026/0149624 A1
(43) Pub. Date: May 28, 2026

(54) COMMUNICATION METHOD AND COMMUNICATION APPARATUS

(71) Applicant: Huawei Technologies Co., Ltd., Shenzhen (CN)

(72) Inventors: Xiaoyan Bi, Shanghai (CN); Jianglei Ma, Ottawa (CA); Yiqun Ge, Ottawa (CA); Wuxian Shi, Kanata (CA)

(21) Appl. No.: 19/409,402

(22) Filed: Dec. 4, 2025

Related U.S. Application Data
(63) Continuation of application No. PCT/CN2023/117563, filed on Sep. 7, 2023.
(60) Provisional application No. 63/506,726, filed on Jun. 7, 2023.

(51) Int. Cl. H04L 25/02; H04B 7/06

(52) U.S. Cl. CPC H04L 25/0202; H04B 7/0634

(57) ABSTRACT

Embodiments of the present application provide a communication method and a communication apparatus. The method includes: receiving reference signals; performing channel estimation based on the reference signals to obtain first channel coefficients corresponding to a first channel; and, obtaining second channel coefficients corresponding to a second channel based on the first channel coefficients and assistance information, the assistance information indicates a relationship between the first channel and the second channel.

### CROSS-REFERENCE TO RELATED APPLICATIONS

This application is a continuation of International Application No. PCT/CN2023/117563, filed on Sep. 7, 2023, which claims priority to U.S. Provisional Patent Application No. 63/506,726, filed on Jun. 7, 2023. The disclosures of the aforementioned applications are hereby incorporated by reference in their entireties.

### TECHNICAL FIELD

Embodiments of the present application relate to the field of communications, and more specifically, to a communication method and a communication apparatus.

### BACKGROUND

In a wireless communication system, to implement functions such as system synchronization, channel information feedback, and data transmission, channel estimation needs to be performed on an uplink channel or a downlink channel.

For performing the channel estimation, reference signals could be transmitted between a network device and a terminal device. How the reference signals are used to perform the channel estimation is an urgent problem to be solved.

### SUMMARY

Embodiments of the present application provide a communication method and a communication apparatus. The technical solutions may improve channel estimation accuracy.

According to a first aspect, an embodiment of the present application provides a communication method, and the method could be performed by a receiving apparatus. The receiving apparatus is a communication device (for example, a base station or a UE) or a chip in the communication device. The method includes: receiving reference signals; performing channel estimation based on the reference signals to obtain first channel coefficients corresponding to a first channel; and, obtaining second channel coefficients corresponding to a second channel based on the first channel coefficients and assistance information, where the assistance information indicates a relationship between the first channel and the second channel.

According to the above technical solution, the assistance information indicates a relationship between different channels (e.g. the first channel and the second channel), and therefore a receiving apparatus could perform channel estimation based on received reference signals to obtain channel coefficients corresponding to one channel, and obtain second channel coefficients corresponding to another channel based on the channel coefficients and the assistance information. This could improve channel estimation accuracy, and, as a transmitting apparatus does not need to transmit reference signals corresponding to the another channel, could save signaling overhead.

In a possible design, the obtaining second channel coefficients corresponding to a second channel based on the first channel coefficients and assistance information includes: obtaining the second channel coefficients corresponding to the second channel by performing a linear or non-linear transformation on the first channel coefficients and the assistance information.

According to the above technical solution, the second channel coefficients could be obtained by performing a linear or non-linear transformation on the first channel coefficients and the assistance information.

In a possible design, the assistance information includes one or more of the following: matrix based information, vector based information, tensor based information, and manifold information.

According to the above technical solution, the type of the assistance information is flexible.

In a possible design, the assistance information is the matrix based information or the tensor based information, and the assistance information is determined based on one or more of the following: a first matrix, and a second matrix, the first matrix and the second matrix represent a channel space basis matrix, and a dimension of the first matrix is larger than a dimension of the second matrix.

In a possible design, the assistance information meets the following form:

$${W}_{aug} = U \cdot {θ}_{aug}^{- 1}$$

where:
W_{aug} represents the assistance information;
U represents the first matrix;
θ_{aug} represents the second matrix, and θ_{aug}=P_{aug}·U, P_{aug} represents a matrix of locations of augment reference signals based on a pivot position on U^{H}, and “H” represents a matrix operation of conjugate transposition; and,
“−1” represents an operation of matrix pseudoinverse.

In a possible design, the second channel coefficients are obtained based on the following form:

$$\hat{y} = {W}_{aug} \cdot y$$

where:
ŷ represents a vector of the second channel coefficients; and
y represents a vector of the first channel coefficients.

In a possible design, the assistance information is the manifold based information, and the assistance information is related to a vector of the first channel coefficients.

In a possible design, the assistance information meets the following form:

$$θ = acos ( \frac{\vert {x}_{0}^{H} \cdot {x}_{s - 1} \vert}{\vert {x}_{0} \vert \cdot \vert {x}_{s - 1} \vert} )$$

$$ϕ = atan ( Im ( \frac{{x}_{0}^{H} \cdot {x}_{s - 1}}{\vert {x}_{0} \vert \cdot \vert {x}_{s - 1} \vert} ) / Re ( \frac{{x}_{0}^{H} \cdot {x}_{s - 1}}{\vert {x}_{0} \vert \cdot \vert {x}_{s - 1} \vert} ) )$$

where:
θ and φ represent the assistance information, and θ is a subspace angle between x₀ and xₛ₋₁;
“acos” is an arcus cosine function;
“H” represents a matrix operation of conjugate transposition;
“atan” is an arcus tangent function;
“Re” and “Im” represent taking real and imaginary parts of a complex number respectively; and,
x₀ and xₛ₋₁ are vectors of the first channel coefficients.

In a possible design, the second channel coefficients are obtained based on the following form:

$${\hat{x}}_{t} = {x}_{0} \cdot α ( θ , ϕ , t ) + {x}_{s - 1} \cdot β ( θ , ϕ , t )$$

where:
\hat{x}ₜ represents the vector of the second channel coefficients;

$$α ( θ , ϕ , t ) = ( cos ( \frac{t + 1}{s} \cdot θ ) - cos ( θ ) \cdot \frac{sin ( \frac{t + 1}{s} \cdot θ )}{sin ( θ )} ) \cdot {e}^{+ 1 j ϕ \cdot \frac{t + 1}{s}} ;$$

“sin” is the arcus sine function;

“1j” represents an imaginary unit;

$$β ( θ , ϕ , t ) = \frac{sin ( \frac{t + 1}{s} \cdot θ )}{sin ( θ )} \cdot {e}^{+ 1 j ϕ \cdot ( \frac{t + 1}{s} - 1 )} ;$$

t represents a relative location of \hat{x}ₜ in between x₀ and xₛ₋₁.

In a possible design, the assistance information is configured by any one of the following: per type of the reference signals, per resource set of the reference signals, or per antenna port of the reference signals.

In a possible design, the assistance information is configured to be any one of: periodical, semi-persistent, or aperiodic.

In a possible design, the method further includes: receiving the assistance information.

According to a second aspect, an embodiment of the present application provides a communication method, and the method could be performed by a transmitting apparatus. The transmitting apparatus is a communication device (for example, a base station or a UE) or a chip in the communication device. The method includes: transmitting reference signals; and, transmitting assistance information, where the assistance information indicates a relationship between a first channel and a second channel, second channel coefficients corresponding to the second channel are determined based on first channel coefficients corresponding to the first channel and the assistance information, and the first channel coefficients are obtained based on channel estimation of the first channel with the reference signals.

In a possible design, the second channel coefficients are determined by performing a linear or non-linear transformation on the first channel coefficients and the assistance information.

In a possible design, the assistance information includes one or more of the following: matrix based information, vector based information, tensor based information, and manifold information.

In a possible design, the assistance information is the matrix based information or the tensor based information, and the assistance information is determined based on one or more of the following: a first matrix, and a second matrix, the first matrix and the second matrix represent a channel space basis matrix, and a dimension of the first matrix is larger than a dimension of the second matrix.

In a possible design, the assistance information meets the following form:

$${W}_{aug} = U \cdot {θ}_{aug}^{- 1}$$

where:
W_{aug} represents the assistance information;
U represents the first matrix;
θ_{aug} represents the second matrix, and θ_{aug}=P_{aug}·U, P_{aug} represents a matrix of locations of augment reference signals based on a pivot position on U^{H}, and “H” represents a matrix operation of conjugate transposition; and,
“−1” represents an operation of matrix pseudoinverse.

In a possible design, the second channel coefficients are obtained based on the following form:

$$\hat{y} = {W}_{aug} \cdot y$$

where:
ŷ represents a vector of the second channel coefficients; and
y represents a vector of the first channel coefficients.

In a possible design, the assistance information is the manifold based information, and the assistance information is related to a vector of the first channel coefficients.

In a possible design, the assistance information meets the following form:

$$θ = acos ( \frac{\vert {x}_{0}^{H} \cdot {x}_{s - 1} \vert}{\vert {x}_{0} \vert \cdot \vert {x}_{s - 1} \vert} )$$

$$ϕ = atan ( Im ( \frac{{x}_{0}^{H} \cdot {x}_{s - 1}}{\vert {x}_{0} \vert \cdot \vert {x}_{s - 1} \vert} ) / Re ( \frac{{x}_{0}^{H} \cdot {x}_{s - 1}}{\vert {x}_{0} \vert \cdot \vert {x}_{s - 1} \vert} ) )$$

where:
θ and φ represents the assistance information, and θ is a subspace angle between x₀ and xₛ₋₁;
“acos” is an arcus cosine function;
“H” represents a matrix operation of conjugate transposition;
“atan” is an arcus tangent function;
“Re” and “Im” represent taking real and imaginary parts of a complex number respectively; and
x₀ and xₛ₋₁ are vectors of the first channel coefficients.

In a possible design, the second channel coefficients are obtained based on the following form:

$${\hat{x}}_{t} = {x}_{0} \cdot α ( θ , ϕ , t ) + {x}_{s - 1} \cdot β ( θ , ϕ , t )$$

where:
\hat{x}ₜ represents the vector of the second channel coefficients;

$$α ( θ , ϕ , t ) = ( cos ( \frac{t + 1}{s} \cdot θ ) - cos ( θ ) \cdot \frac{sin ( \frac{t + 1}{s} \cdot θ )}{sin ( θ )} ) \cdot {e}^{+ 1 j ϕ \cdot \frac{t + 1}{s}} ;$$

“sin” is an arcus sine function;
“1j” represents the imaginary unit;

$$β ( θ , ϕ , t ) = \frac{sin ( \frac{t + 1}{s} \cdot θ )}{sin ( θ )} \cdot {e}^{+ 1 j ϕ \cdot ( \frac{t + 1}{s} - 1 )} ,$$

t represents a relative location of \hat{x}ₜ in between x₀ and xₛ₋₁.

In a possible design, the assistance information is configured by any one of the following: per type of the reference signals, per resource set of the reference signals, or per antenna port of the reference signals.

In a possible design, the assistance information is configured to be any one of: periodical, semi-persistent, or aperiodic.

Various implementations of the second aspect correspond to various implementations of the first aspect. For the various implementations and the beneficial technical effects of the various implementations of the second aspect, reference may be made to the descriptions of the relevant implementations of the first aspect, which will not be repeated here.

According to a third aspect, a communication apparatus is provided, and configured to perform the method in any possible implementation of the foregoing aspects. Specifically, the apparatus includes a unit configured to perform the method in any possible implementation of the foregoing aspects.

According to a fourth aspect, another communication apparatus is provided, including a processor. The processor is coupled to a memory, and may be configured to execute one or more instructions in the memory, to implement the method in any possible implementation of the various aspects. The memory may be an on-chip storage unit inside the processor, or may be an off-chip storage unit that is coupled to the memory and located outside the processor. In a possible implementation, the apparatus further includes the memory. In a possible implementation, the apparatus further includes a communication interface, and the processor is coupled to the communication interface.

In a possible design, the communication apparatus may be a transmitting apparatus (for example, a base station or a user equipment), may be a chip, a circuit, or a processing system configured in the transmitting apparatus, or may be a device including the transmitting apparatus.

In a possible design, the communication apparatus may be a receiving apparatus (for example, a base station or a user equipment), may be a chip, a circuit, or a processing system configured in the receiving apparatus, or may be a device including the receiving apparatus.

According to a fifth aspect, a computer-readable storage medium is provided. The computer-readable storage medium stores a computer program, and when the computer program is executed by a communication apparatus, the communication apparatus is enabled to implement the method in any possible implementation of the foregoing aspects.

According to a sixth aspect, a computer program product including one or more instructions is provided. When the instructions are executed by a computer, a communication apparatus is enabled to implement the method in any possible implementation of the foregoing aspects.

According to a seventh aspect, a communication system is provided, including the foregoing transmitting apparatus and the foregoing receiving apparatus.

### DESCRIPTION OF DRAWINGS

FIG. 1 is a schematic diagram of an application scenario according to this application;

FIG. 2 illustrates an example communication system 100;

FIG. 3 illustrates another example of an electronic device (ED) 110 and a base station 170a, 170b and/or 170c;

FIG. 4 is an example of a channel model of a multiple-input multiple-output (MIMO) system;

FIG. 5 is an example of a process in which the base station obtains channel state information (CSI);

FIG. 6 is a schematic flowchart of a communication method 600 according to an embodiment of this application;

FIGS. 7A-7C are illustrations of assistance information (matrix based information) used to obtain second channel coefficients;

FIG. 8 is an illustration of assistance information (manifold information) used to obtain second channel coefficients;

FIG. 9 is an illustration of assistance information (matrix based information and the manifold information) used to obtain second channel coefficients;

FIG. 10 is a schematic block diagram of a communication apparatus according to an embodiment of this application;

FIG. 11 is a schematic block diagram of another communication apparatus according to an embodiment of this application;

FIG. 12 is a flow chart of embodiment 1;

FIG. 13 is an illustration of channel estimation or channel filtering;

FIG. 14 is an illustration of channel interpolation;

FIG. 15 is a flow chart of embodiment 2;

FIG. 16 is a flow chart of embodiment 3;

FIG. 17 is an illustration of using manifold based assisted information of channel estimation;

FIG. 18 is a flow chart of embodiment 4;

FIG. 19 is an illustration of using both matrix based and manifold based assisted information of channel estimation;

FIG. 20 is a flow chart of embodiment 5;

FIG. 21 is a flow chart of embodiment 6-1;

FIG. 22 is an illustration of the assisted information of channel estimation containing Rx port only in time/frequency domain;

FIG. 23 is a flow chart of embodiment 7-1;

FIG. 24 is an illustration of the assisted information of channel estimation containing Tx and Rx ports in time/frequency domain; and

FIG. 25 illustrates units or modules in a device.

### DESCRIPTION OF EMBODIMENTS

The following describes technical solutions of the present application with reference to the accompanying drawings.

The technical solutions in embodiments of this application may be applied to multiple-input multiple-output (MIMO) technology. And the technical solutions in embodiments of this application may be applied to various communication systems, such as a fifth generation (5G) wireless communication system, a new ratio (NR) wireless communication system, a Long Term Evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

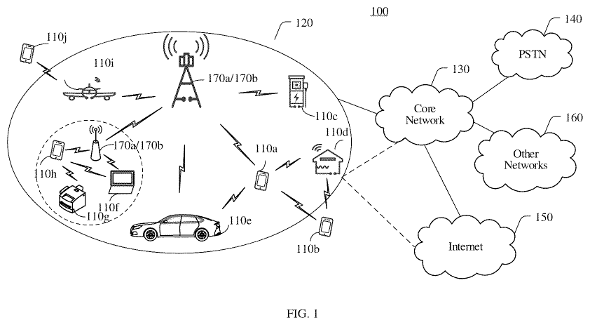

For ease of understanding of the embodiments of this application, a communication system shown in FIG. 1-FIG. 3 is used as an example to describe in detail a communication system to which the embodiments of this application are applicable.

Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as ED 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the Internet 150, and other networks 160.

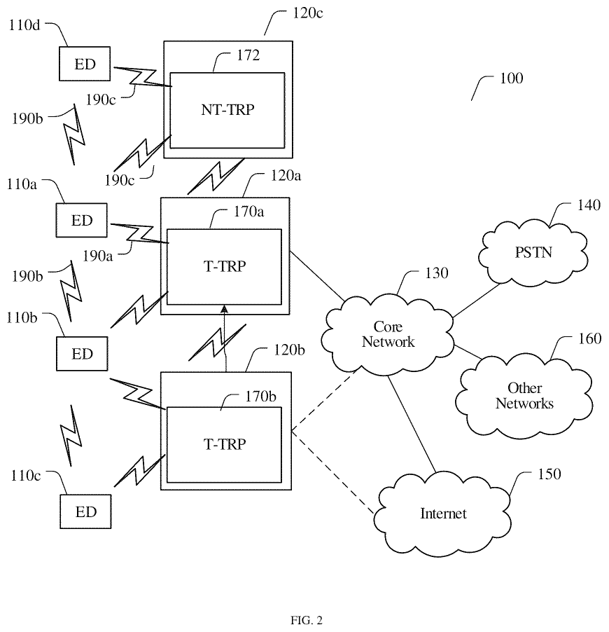

Referring to FIG. 2, an example communication system 100 is illustrated. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 19b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 19b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 1200b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such.

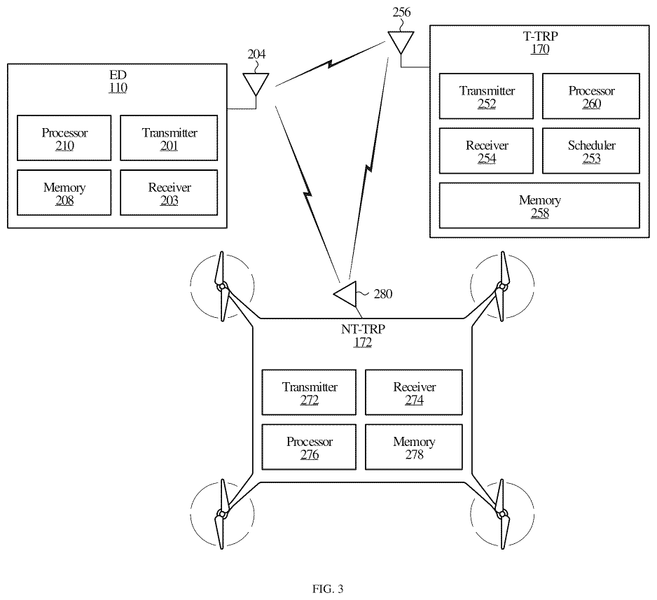

Referring to FIG. 3, another example of an ED 110 and a base station 170a, 170b and/or 170c is illustrated. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or an apparatus (e.g. a communication module, a modem, or a chip) in the forgoing devices, among other possibilities. Future generation EDs 110 may be referred to as other terms. The base station 170a and 170b is a T-TRP and will hereafter be referred to as T-TRP 170. Also, as shown in FIG. 3, an NT-TRP will hereafter be referred to as NT-TRP 172. Each ED 110 connected to T-TRP 170 and/or NT-TRP 172 can be dynamically or semi-statically turned on (i.e., established, activated, or enabled), turned off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmissions to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be reference signals transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations related to network access (e.g. initial access) and/or downlink synchronization, such as operations related to detecting a synchronization sequence, decoding and obtaining the system information, etc. In some embodiments, the processor 210 may perform channel estimation, e.g. using reference signals received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and the receiver 203 may each be implemented by the same or different one or more processors that are configured to execute instructions stored in a memory (e.g. in memory 208). Alternatively, some or all of the processor 210, and the processing components of the transmitter 201 and the receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. a communication module, a modem, or a chip) in the foregoing devices.

The CU (or CU-control plane (CP) and CU-user plane (UP)), DU or RU may be known by other names in some implementations. For example, in an open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remotely from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations related to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by a scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and executed by the processor 260.

Although not illustrated, the processor 260 may form part of the transmitter 252 and/or the receiver 254. Also, although not illustrated, the processor 260 may implement the scheduler 253. Although not illustrated, the memory 258 may form part of the processor 260.

The processor 260, the scheduler 253, and the processing components of the transmitter 252 and the receiver 254 may each be implemented by the same or different one or more processors that are configured to execute instructions stored in a memory, e.g. in memory 258. Alternatively, some or all of the processor 260, the scheduler 253, and the processing components of the transmitter 252 and the receiver 254 may be implemented using dedicated circuitry, such as an FPGA, a GPU, or an ASIC.

The NT-TRP 172 is illustrated as a drone only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and the receiver 274 may each be implemented by the same or different one or more processors that are configured to execute instructions stored in a memory, e.g. in memory 278. Alternatively, some or all of the processor 276 and the processing components of the transmitter 272 and the receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding of the embodiments of this application, the following briefly describes several terms used in this application.

### 1) Multiple-Input Multiple-Output (MIMO)

MIMO technology allows an antenna array of multiple antennas to perform signal transmissions and receptions to meet high transmission rate requirements. The above ED110 and T-TRP 170, and/or NT-TRP use MIMO to communicate over wireless resource blocks. MIMO utilizes multiple antennas at the transmitting apparatus and/or receiving apparatus to transmit the wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attention from the academia and the industry. In the large-scale MIMO system, the T-TRP 170 and/or NT-TRP 172 is generally configured with more than ten antenna units (such as 128 or 256), and serves for dozens of the EDs 110. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase in the number of antennas allows each antenna unit to be made smaller and at a lower cost. Using the degree of spatial freedom provided by the large-scale antenna units, the T-TRP 170 and NT-TRP 172 of each cell can communicate with many EDs 110 in the cell on the same time-frequency resource at the same time, thus greatly increasing the spectrum efficiency. A large number of antenna units of the T-TRP 170 and/or NT-TRP 172 also enable each user to have better spatial directivity for uplink and downlink transmission, so that the transmitting power of the T-TRP 170 and/or NT-TRP 172 and an ED 110 is reduced, and the power efficiency is greatly increased. When the number of antennas of the T-TRP 170 and/or NT-TRP 172 is sufficiently large, random channels between each ED 110 and the T-TRP 170 and/or NT-TRP 172 can be close to be orthogonal, and the interference between the cell and the users and the effect of noises can be eliminated. The plurality of advantages described above enable the large-scale MIMO to have a magnificent application prospect.

A MIMO system may include a receiving apparatus connected to a receive (Rx) antenna, a transmitting apparatus connected to a transmit (Tx) antenna, and a signal processor connected to the transmitting apparatus and the receiving apparatus. Each of the Rx antenna and the Tx antenna may include a plurality of antennas. For instance, the Rx antenna may have a ULA antenna array in which the plurality of antennas are arranged in a line at even intervals. When a radio frequency (RF) signal is transmitted through the Tx antenna, the Rx antenna may receive a signal reflected and returned from a forward target. The receiving apparatus could be an ED (i.e. ED110) and the transmitting apparatus could be a T-TRP or NT-TRP (i.e. T-TRP 170 or NT-TRP 172), or the receiving apparatus could be a T-TRP or NT-TRP (i.e. T-TRP 170 or NT-TRP 172) and the transmitting apparatus could be an ED (i.e. ED110).

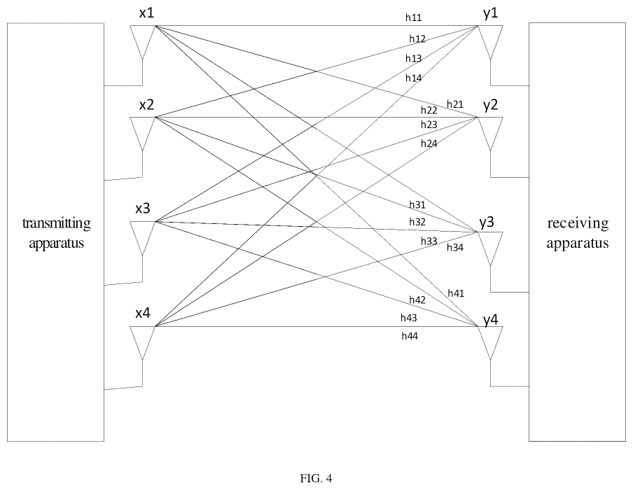

Referring to FIG. 4, as an illustrative example without limitation, a simplified schematic illustration of a communication scenario is provided. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

Hereafter, a base station is used as an example of T-TRP 170 or NT-TRP 172, and the UE is used as an example of ED 110. A receiving apparatus may be referred to as ED 110 for a downlink transmission, and T-TRP 170 or NT-TRP 172 for an uplink transmission. A transmitting apparatus may be referred to as T-TRP 170 or NT-TRP 172 for a downlink transmission, and ED 110 for an uplink transmission. However, limitation is not made herein.

### 2) Channel Estimation

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, reference signals predicted by a transmitting apparatus and a receiving apparatus may be used to track a change in the time domain and/or frequency domain of a channel, so as to reconstruct or restore a received signal. The reference signals may also be referred to as a pilot signal, a reference sequence or the like, and are described as reference signals in the following for ease of understanding. The reference signal includes, for example, a channel state information-reference signal (CSI-RS), a sounding reference signal (SRS), a demodulation reference signal (DMRS), a phase track reference signal (PT-RS), or a cell reference signal (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e. a UE) may perform channel estimation on each physical antenna port based on a CSI-RS sent by a transmitting apparatus ((i.e. a base station), to feedback channel state information (CSI) based on a channel estimation result. The CSI may include one or more of: a channel quality indicator (CQI), a precoding matrix indicator (PMI), and a layer indicator (LI). The CSI is used to reconstruct or precode the downlink channel. In some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

In an implementation, a transmitting apparatus maps a sequence of reference signals to certain physical resources, and transmits the reference signals over the certain physical resources, where the sequence of reference signals and the physical resources are known to both the transmitting apparatus and the receiving apparatus receiving the reference signals. Thus, the receiving apparatus could perform channel estimation based on the received reference signals.

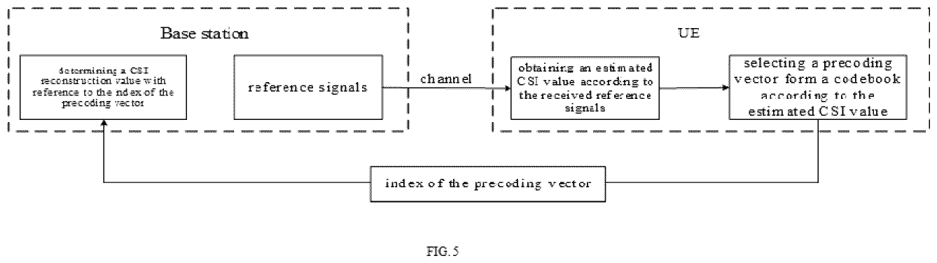

Referring to FIG. 5, in some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

The process of transmitting reference signals described below may be performed by a base station, or may be performed by a UE. The process of measuring a channel may be performed by the UE when the base station transmits the reference signals, and may be performed by the base station when the UE transmits the reference signals. For ease of description, an apparatus that transmits the reference signals is herein after referred to as a transmitting apparatus and an apparatus that measures a channel based on the reference signals is herein after referred to as a receiving apparatus.

### 3) Antenna Port

An antenna port, which may also be referred to as port for short, is a transmitting antenna identified by a receiver, or a transmitting antenna that can be distinguished in spatial domain. For each virtual antenna, one antenna port may be configured, and each virtual antenna may be a weighted combination of multiple physical antennas. Each antenna port may correspond to one reference signals port.

### 4) Quasi-Co-Location (QCL)

Two antenna ports are said to be quasi co-located if the large-scale properties (or channel features) of the channel over which a symbol on one antenna port is conveyed can be inferred from the channel over which a symbol on the other antenna port is conveyed.

The large-scale properties (or channel features) may include one or more of the following: delay spread, Doppler spread, Doppler shift, average delay, average gain, and Spatial RX parameter. The spatial RX parameter may include, for example, angle of arrival (AOA), average AOA, AOA spread, angle of departure (AOD), average AOD, AOD spread, and RX antenna spatial correlation parameter, Tx antenna spatial correlation parameter, transmit beam, receive beam, resource identifier, and the like.

The angle mentioned above may be decomposition values of different dimensions, or a combination of decomposition values of different dimensions. The two antenna ports mentioned above may be antenna ports with different antenna port numbers, and/or, antenna ports with a same antenna port number that send or receive information in different time and/or frequency and/or code domain resources, and/or, the antenna ports with different antenna port numbers send or receive information in different time and/or frequency and/or code domain resources. The resource identifier may include, for example, a CSI-RS resource identifier, an SRS resource identifier, a synchronization signal/synchronization signal block resource identifier, a demodulation reference signal (DMRS) resource identifier, or a resource identifier of preamble sequence transmitted on a physical random access channel (PRACH).

3GPP has introduced QCL concept in LTE and 5G to help a receiving apparatus with channel estimation. For example, if the receiving apparatus obtains that channels corresponding to two different antenna ports are QCL in terms of the Doppler shift, then the receiving apparatus could determine the Doppler shift for one antenna port and then apply the result on both antenna ports for channel estimation. This avoids the receiving apparatus to calculate doppler for both antenna ports separately. It can be seen from above, 3GPP utilizes commonality of different antenna ports only, other than correlation among the different antenna ports, which could help to improve channel estimation accuracy. In view of this, the embodiments of this application provide assistance information for channel estimation. The assistance information could indicate correlation among different channels, for example, the assistance information indicates a relationship between a first channel and a second channel, and a receiving apparatus could obtain coefficients of the second channel based on coefficients of the first channel and the assistance information. This could improve channel estimation accuracy, and, as a transmitting apparatus does not need transmit reference signals corresponding to the second channel to obtain the second channel coefficients, could save signaling overhead.

The following describes the embodiments of this application in detail with reference to the accompanying drawings.

In this application, upper notation “H” represents a matrix operation of conjugate transposition, and upper notation “−1” represents an operation of matrix pseudoinverse.

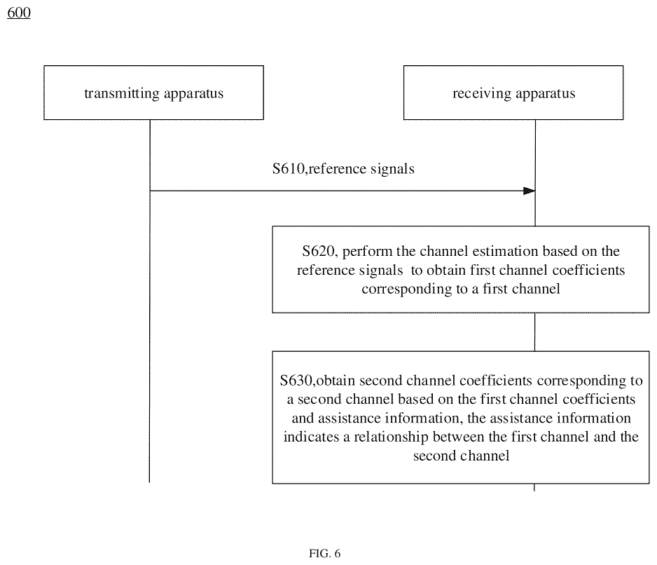

Referring to FIG. 6, a schematic flowchart of a communication method 600 according to an embodiment of this application is shown. The communication method 600 may be applied to the communication system 100 shown in FIG. 1.

At S610, a receiving apparatus receives reference signals.

Correspondingly, a transmitting apparatus transmits the reference signals.

For an example, the receiving apparatus is a base station, and the transmitting apparatus is a UE. In this example, the reference signals are uplink reference signals, e.g. SRS, DMRS for physical uplink share channel (PUSCH).

For another example, the receiving apparatus is a UE, and the transmitting apparatus is a base station. In this example, the reference signals are downlink reference signals, e.g. CSI-RS, DMRS for physical downlink share channel (PDSCH).

At S620, the receiving apparatus performs channel estimation based on the reference signals to obtain first channel coefficients corresponding to a first channel.

In this application, channel coefficients represent one or more values of a channel matrix. For example, the receiving apparatus performs channel estimation based on the reference signals, and determines a matrix of the first channel based on a channel estimation result, and values of the matrix of the first channel could be referred to as the first channel coefficients.

This application does not limit how to obtain the channel matrix. For example, the channel matrix could be obtained by: Y=H·S, or, Y=H·S+N, Y represents reference signals received, S represents reference signals transmitted, and N represents channel noise.

At S630, the receiving apparatus obtains second channel coefficients corresponding to a second channel based on the first channel coefficients and assistance information, the assistance information indicates a relationship between the first channel and the second channel.

The assistance information indicates a relationship between the first channel and the second channel, and thus the receiving apparatus could obtain the second channel coefficients based on the first channel coefficients and the assistance information.

In a possible implementation, the first channel and the second channel could be represented by different locations, and therefore the assistance information could indicate a relationship between the different locations. A location can be generally represented through three dimensions of time, frequency and space. Therefore, the assistance information could indicate a relationship between one or more of: different time domain locations, different frequency domain locations, or different space domain locations. For example, the assistance information could indicate one or more of: Tx antenna ports in time domain, Tx antenna ports in frequency domain, Rx antenna ports in time domain, and Rx antenna ports in frequency domain. The space domain locations could be represented by antenna ports, e.g. Tx antenna ports, and Rx antenna ports.

In another possible implementation, the first channel and the second channel could be represented by same locations. In this implementation, that the second channel coefficients are obtained based on the first channel coefficients and the assistance information could be referred to a process of reconstructing or restoring received signals to compensate for signal distortion caused by channel fading and noise. For example, the first channel and the second channel could be represented by locations of reference signals, where the first channel represents the channel from a Tx antenna port to an Rx antenna port without considering signal distortion, and the second channel represents the channel from the Tx antenna port to the Rx antenna port with considering signal distortion.

In some embodiments, the assistance information could indicate one or more of: Tx antenna ports in time domain, Tx antenna ports in frequency domain, Rx antenna ports in time domain, and Rx antenna ports in frequency domain.

In a possible implementation, the assistance information could indicate Tx antenna ports in frequency domain or in time domain. Specifically, the assistance information could indicate a relationship between two channels (e.g. the first channel and the second channel) corresponding to two different Tx antenna ports. For an example, if the reference signals are CSI-RSs, then the Tx antenna ports refer to transmitting antenna ports at a base station side. For another example, if the reference signals are DMRSs for PDSCH/PDCCH, then Tx antenna ports refer to DMRS antenna ports for PDSCH/PDCCH.

In another possible implementation, the assistance information could indicate Rx ports in frequency domain or in time domain. Specifically, the assistance information could indicate a relationship between two channels (e.g. the first channel and the second channel) corresponding to two different Rx antenna ports. For an example, if the reference signals are SRSs, then the Rx antenna ports refer to receiving antenna ports at a base station side. For another example, if the reference signals are DMRSs for PUSCH/physical uplink control channel (PUCCH), then Rx antenna ports refer to DMRS antenna ports for PUSCH/PUCCH.

In another possible implementation, the assistance information could indicate Rx antenna ports in frequency domain or in time domain, and Tx antenna ports in frequency domain or in time domain. Specifically, the assistance information could indicate a relationship between two channels (e.g. the first channel and the second channel) corresponding to two different Rx antenna ports and Tx antenna ports. For an example, if the reference signals are SRSs, then the Rx antenna ports refer to receiving antenna ports at a base station side, and the Tx antenna ports refer to transmitting antenna ports at a UE side. For another example, if the reference signals are DMRSs for PUSCH/PUCCH, then Rx antenna ports refer to DMRS antenna ports for PUSCH/PUCCH, and the Tx antenna ports refer to transmitting antenna ports at a UE side.

In some embodiments, the receiving apparatus obtains the second channel coefficients by performing a linear or non-linear transformation on the first channel coefficients and the assistance information.

In some embodiments, the assistance information includes one or more of: matrix based information, vector based information, tensor based information, and manifold information. There are some examples.

Example #1: The assistance information is the matrix based information.

The assistance information could indicate one or more of: time domain information, frequency domain information, and space domain information. Specifically, in this Example #1, the assistance information could be a matrix. For example, the assistance information includes rows and columns, where rows and columns could represent any two of: Tx antenna ports, Rx antenna ports, frequency domain locations, and time domain locations.

For example, the assistance information could indicate a relationship of different Rx antenna ports on a certain location (for example, a location of frequency domain radio resource, and/or, a location of time domain radio resource), the different Rx antenna ports includes a first Rx antenna port corresponding to the first channel and a second Rx antenna port corresponding to the second channel. The receiving apparatus could perform channel estimation based on reference signals received by the first Rx antenna port, and obtain the first channel coefficients; and the receiving apparatus could obtain the second channel coefficients based on the first channel coefficients and the assistance information.

In some embodiments, in this Example #1, the assistance information is determined based on one or more of the following: a first matrix, and a second matrix. The first matrix and the second matrix represent a channel space basis matrix, and a dimension of the first matrix is larger than a dimension of the second matrix. For example, the first matrix indicates a relationship between the entire antenna ports, and the second matrix is equivalent to select several locations from the first matrix, so that the dimension is reduced.

In a possible implementation, the assistance information meets Form 1.

$${W}_{aug} = U \cdot {θ}_{aug}^{- 1} \qquad Form 1$$

The parameters in Form 1 are explained below.

(1) W_{aug} represents the assistance information.

[symbol]

For example, W_{aug}∈ [symbol] ^{s×r}^{_{aug}}, where s represents a number of resources allocated to the second channel, r_{aug} represents an augment number of resources allocated to the reference signals, and C represents a complex matrix. A dimension of the second channel coefficients could be larger than or equal to the dimension of the first channel coefficients, that is s≥r_{aug}. If s>r_{aug}, then a procedure during which the receiving apparatus obtains the second channel coefficients based on the first channel coefficients and the assistance information could be referred to as channel interpolation. If s=r_{aug}, then the procedure during which the receiving apparatus obtains the second channel coefficients based on the first channel coefficients and the assistance information could be referred to as channel estimation or channel filtering.

(2) U represents the first matrix.

For example, U∈ [symbol] ^{s×r}, r represents a number of resources allocated to reference signals, and s≥r. For an example, r is selected so that an accumulated value of the top r singular values of a channel matrix is no less than a first threshold. For another example, r is selected so that a resource density is not larger than a second threshold. An index set of resources allocated to the reference signals is a subset of an index set of augment resources allocated to the reference signals, which means r_{aug}≥r.

In a possible implementation, the U could be determined by performing matrix decomposition singular vector decomposition (SVD) on H, where H∈ [symbol] ^{s×m}. The H could be a training channel matrix for determining the assistance information. For example,

$$H = {U}_{0} \cdot {\sum }_{0} \cdot {V}_{0}^{H} ,$$

where U₀ is a unitary matrix, and U₀∈ [symbol] ^{s×m}. For example, assume s m, then U could be determined by selecting the top r column vectors of U₀.

Physical meanings of the H and m depend on a type of reference signals. For an example, if the reference signals are CSI-RSs, H represents a downlink raw channel, and m could at least include Rx antenna ports. For another example, if the reference signals are DMRSs for PDSCH/PDCCH, H represents a downlink equivalent channel (the channel with precoding), and m could at least include Rx antenna ports. For another example, if the reference signals are SRSs, H represents an uplink raw channel, and m could at least include Rx antenna ports. For another example, if the reference signals are DMRSs for PUSCH/PUCCH, H represents an uplink equivalent channel (the channel with precoding), and m could at least include Rx antenna ports.

(3) θ_{aug} represents the second matrix.

θ_{aug}=P_{aug}·U, P_{aug} represents a matrix of locations of augment reference signals based on a pivot position on U^{H}, and θ_{aug}∈ [symbol] ^{r}^{_{aug}}^{×r}, P_{aug}∈ [symbol] ^{r}^{_{aug}}^{×s}.

In a possible implementation, the second channel coefficients are obtained based on Form 2.

$$\hat{y} = {W}_{aug} \cdot y \qquad Form 2$$

The parameters in Form 2 are explained below.
ŷ represents a vector of the second channel coefficients, and ŷ∈ [symbol] ^{s×1}
y represents a vector of the first channel coefficients, and y∈ [symbol] ^{r}^{_{aug}}^{×1}.

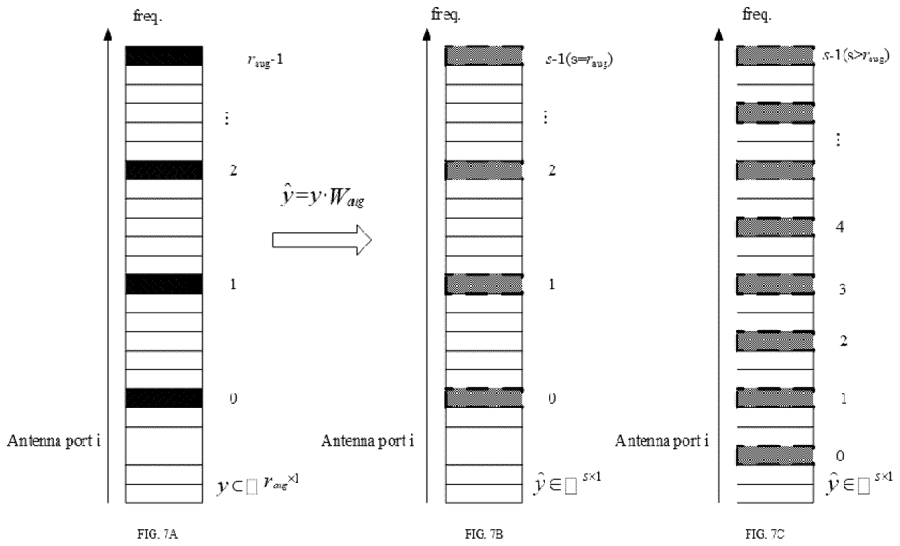

Referring to FIGS. 7A-7C, an illustration of assistance information (matrix based information) used to obtain second channel coefficients are shown. As shown in FIG. 7A, a transmitting apparatus uses antenna port i to transmit reference signals on four locations as shown in a shaded part of FIG. 7A, and correspondingly, the receiving apparatus receives the reference signals. A receiving apparatus performs channel estimation based on the reference signals to obtain a vector of first channel coefficients y as shown in FIG. 7A, and y∈ [symbol] ^{r}^{_{aug}}^{×1}. Assume s=r_{aug}, the receiving apparatus obtains a vector of second channel coefficients y based on the Form 2 as shown in a shaded part of FIG. 7B, and for example, a procedure during which the receiving apparatus obtains the vector of the second channel coefficients could be referred to as channel estimation or channel filtering. Assume s>r_{aug}, the receiving apparatus obtains the vector of the second channel coefficients ŷ based on the Form 2 as shown in a shaded part of FIG. 7C, and for example, a procedure during which the receiving apparatus obtains the vector of the second channel coefficients could be referred to as channel interpolation.

Example #2: The assistance information is the tensor based information.

The assistance information could indicate one or more of: time domain information, frequency domain information, and space domain information. Specifically, in this Example #2, the assistance information could be three-dimensional, and for example, the assistance information could indicate any three of: Tx antenna ports, Rx antenna ports, frequency domain locations, and time domain locations.

For example, the assistance information could indicate a relationship of different Tx antenna ports and different Rx antenna ports on a certain location (for example, a location of frequency domain radio resource, and/or, a location of time domain radio resource), the different Tx antenna ports include a first Tx antenna port corresponding to the first channel and a second Tx antenna port corresponding to the second channel, and the different Rx antenna ports include a first Rx antenna port corresponding to the first channel and a second Rx antenna port corresponding to the second channel. The receiving apparatus could perform channel estimation based on reference signals which transmitted by the first Tx antenna port and received by the first Rx antenna port, and obtain the first channel coefficients; and the receiving apparatus could obtain the second channel coefficients based on the first channel coefficients and the assistance information.

In a possible implementation, in this Example #2, the assistance information meets the Form 2.

The Example #2 is similar to the Example #1, and the difference is that the first matrix U is determined by using different manners. In the Example #2, in a possible implementation, the U could be determined by performing matrix decomposition high order singular vector decomposition (HOSVD) on [symbol] , where [symbol] ∈ [symbol] ^{s×n×m}. The [symbol] could be a training channel tensor for determining the assistance information. For example, [symbol] = [symbol] ₀·U₀·S₀·V₀, where [symbol] ₀ represents a core channel tensor, [symbol] ₀∈ [symbol] ^{s′×n′×m′}, s′≤s, and U₀∈ [symbol] ^{s×s′}. For example, U could be determined by selecting the top r column vectors of U₀.

Physical meaning of [symbol] and m depend on a type of reference signals. For an example, if the reference signals are CSI-RSs, [symbol] represents a downlink raw channel, and m could at least include Rx antenna ports. For another example, if the reference signals are DMRSs for PDSCH/PDCCH, [symbol] represents a downlink equivalent channel (the channel with precoding), m could at least include Rx antenna ports, and n could at least include MU UEs. For another example, if the reference signals are SRSs, [symbol] represents an uplink raw channel, and m could at least include Rx antenna ports. For another example, if the reference signals are DMRSs for PUSCH/PUCCH, [symbol] represents an uplink equivalent channel (the channel with precoding), and m could at least include Rx antenna ports, and n could at least include MU UEs.

In a possible implementation, the second channel coefficients are obtained based on the Form 2. This implementation is described in detail on above, and for brevity, details are not described herein again.

Example #3: The assistance information is the manifold information.

The assistance information could indicate one or more of: time domain information, frequency domain information, and space domain information. Specifically, in this Example #3, the assistance information could indicate a path of different locations in a same domain, e.g. two different frequency domain locations.

For example, the assistance information could indicate a relationship of different frequency domain locations, and the different frequency domain locations include a location corresponding to the first channel and a location corresponding to the second channel. The receiving apparatus could perform channel estimation based on reference signals received, and obtain the first channel coefficients; and the receiving apparatus could obtain the second channel coefficients based on the first channel coefficients and the assistance information.

In some embodiments, the assistance information is related to a vector of the first channel coefficients.

In a possible implementation, the assistance information meets Form 3.

$$θ = acos ( \frac{\vert {x}_{0}^{H} \cdot {x}_{s - 1} \vert}{\vert {x}_{0}^{} \vert \cdot \vert {x}_{s - 1} \vert} ) ; \qquad Form 3$$

$$ϕ = atan ( Im ( \frac{{x}_{0}^{H} \cdot {x}_{s - 1}}{\vert {x}_{0}^{} \vert \cdot \vert {x}_{s - 1} \vert} ) / Re ( \frac{{x}_{0}^{H} \cdot {x}_{s - 1}}{\vert {x}_{0}^{} \vert \cdot \vert {x}_{s - 1} \vert} ) )$$

The parameters in Form 3 are explained below.

θ and φ represent the assistance information, and θ is a subspace angle between x₀ and xₛ₋₁. “acos” is an arcus cosine function. “atan” is an arcus tangent function. “Re” and “Im” represent taking real and imaginary parts of a complex number respectively. x₀ and xₛ₋₁ are vectors of the first channel coefficients. For example, x₀∈ [symbol] ^{k×1}, and xₛ₋₁∈ [symbol] ^{k×1}. k represents the number of Rx antenna ports.

Physical meaning of the x₀ and xₛ₋₁ depend on a type of reference signals. For an example, if the reference signals are CSI-RSs, x₀ and xₛ₋₁ could represent downlink raw channel vectors. For another example, if the reference signals are DMRSs for PDSCH/PDCCH, x₀ and xₛ₋₁ could represent downlink equivalent channel vectors (the channel with precoding). For another example, if the reference signals are SRSs, x₀ and xₛ₋₁ could represent uplink raw channel vectors. For another example, if the reference signals are DMRSs for PUSCH/PUCCH, x₀ and xₛ₋₁ could represent uplink equivalent channel vectors (the channel with precoding).

In a possible implementation, the second channel coefficients are obtained based on Form 4.

$${\hat{x}}_{t} = {x}_{0} \cdot α ( θ , ϕ , t ) + {x}_{s - 1} \cdot β ( θ , ϕ , t ) \qquad Form 4$$

The parameters in Form 4 are explained below.

\hat{x}ₜ represents the vector of the second channel coefficients. For example, \hat{x}∈ [symbol] ^{k×1}.

$$α ( θ , ϕ , t ) = ( cos ( \frac{t + 1}{s} \cdot θ ) - cos ( θ ) \cdot \frac{sin ( \frac{t + 1}{s} \cdot θ )}{sin ( θ )} ) \cdot {e}^{+ 1 j ϕ \cdot \frac{t + 1}{s}} .$$

“sin” is the arcus sine function. “1j” represents an imaginary unit.

$$β ( θ , ϕ , t ) = \frac{sin ( \frac{t + 1}{s} \cdot θ )}{sin ( θ )} \cdot {e}^{+ 1 j ϕ \cdot ( \frac{t + 1}{s} - 1 )} . t$$

represents a relative location of \hat{x}ₜ in between x₀ and xₛ₋₁, and o≤t≤s.

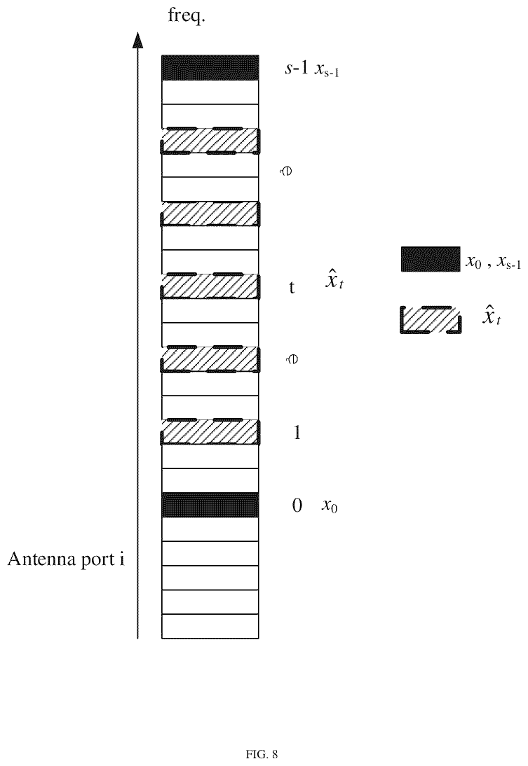

Referring to FIG. 8, an illustration of assistance information (manifold information) used to obtain second channel coefficients are shown. As shown in FIG. 8, the transmitting apparatus uses antenna port i to transmit the reference signals on two locations as shown in a black shaded part of FIG. 8, and correspondingly, the receiving apparatus receives the reference signals. The receiving apparatus performs channel estimation based on the reference signals to obtain the vector of the first channel coefficients x₀ and xₛ₋₁ as shown in FIG. 8. And the receiving apparatus obtains the vector of the second channel coefficients iₜ based on the Form 4 as shown in a slash shaded part of FIG. 8.

Example #4: The assistance information includes the vector based information.

The assistance information could indicate one or more of: time domain information, frequency domain information, and space domain information. Specifically, in this Example #4, the assistance information could be two-dimensional, and the assistance information could indicate any two of: Tx antenna ports, Rx antenna ports, frequency domain locations, and time domain locations

For example, the assistance information could indicate a relationship of different Tx antenna ports on a certain location (for example, a location of frequency domain radio resource, and/or, a location of time domain radio resource), the different Tx antenna ports include a first Tx antenna port corresponding to the first channel and a second Tx antenna port corresponding to the second channel. The receiving apparatus could perform channel estimation based on reference signals transmitted by the first Tx antenna port, and obtain the first channel coefficients; and the receiving apparatus could obtain the second channel coefficients based on the first channel coefficients and the assistance information.

In a possible implementation, the assistance information could be represented by vi. For example, a vector of the vᵢ indicates a relationship of different Tx antenna ports on a subcarrier #i, e.g. each value of the vᵢ is a correlation coefficient of two different Tx antenna ports on the subcarrier #i. The receiving apparatus could perform channel estimation based on reference signals transmitted by one Tx antenna port of the different Tx antenna ports, and obtain coefficients of one channel corresponding to the one Tx antenna port; and the receiving apparatus could obtain coefficients of other channel corresponding to other Tx antenna port of the different Tx antenna ports based on the coefficients of one channel and the assistance information (vᵢ).

The matrix based information, the vector based information, the tensor based information, and the manifold information are described separately above, and the above information may be used alone or in combination. The following is an example of a combination of the above information.

Example #5: The assistance information includes the matrix based information and the manifold information.

In this Example #5, the assistance information includes the matrix based information and the manifold information, the matrix based information could refer to Example #1, and the manifold information could refer to Example #3.

In some embodiments, the second channel coefficients may be obtained by the following manner: obtaining intermediate channel coefficients based on the first channel coefficients and one of the assistance information, and obtaining the second channel coefficients based on the intermediate channel coefficients and the other assistance information.

In a possible implementation, the second channel coefficients are obtained based on the Form 5.

$${\hat{x}}_{t} = {x}_{0} \cdot α ( θ , ϕ , t ) + {x}_{s - 1} \cdot β ( θ , ϕ , t ) , \qquad Form 5$$

$$where {x}_{0} = [ {\hat{y}}_{0} ( 0 ) ⋯ {{\hat{y}}_{k - 1} ( 0 )}^{T} , and {x}_{s - 1} = {[ {\hat{y}}_{0} ( s - 1 ) ⋯ {\hat{y}}_{k - 1} ( s - 1 ) ]}^{T} .$$

The parameters in Form 5 are explained below.

\hat{x}ₜ represents the vector of the second channel coefficients. For example, \hat{x}∈ [symbol] _{k×1}. ŷₖ₋₁ represents the intermediate channel coefficients, and ŷₖ₋₁∈ [symbol] _{s×1}. ŷₖ₋₁(0) represents 1^{st} element of ŷₖ₋₁, ŷₖ₋₁(s−1) represents s^{th} element of ŷₖ₋₁. “k−1” means the k^{th} Rx antenna ports. ŷₖ₋₁(0) could be obtained based on Form 2. The explanation of other parameters could refer to Example #1 and Example #3.

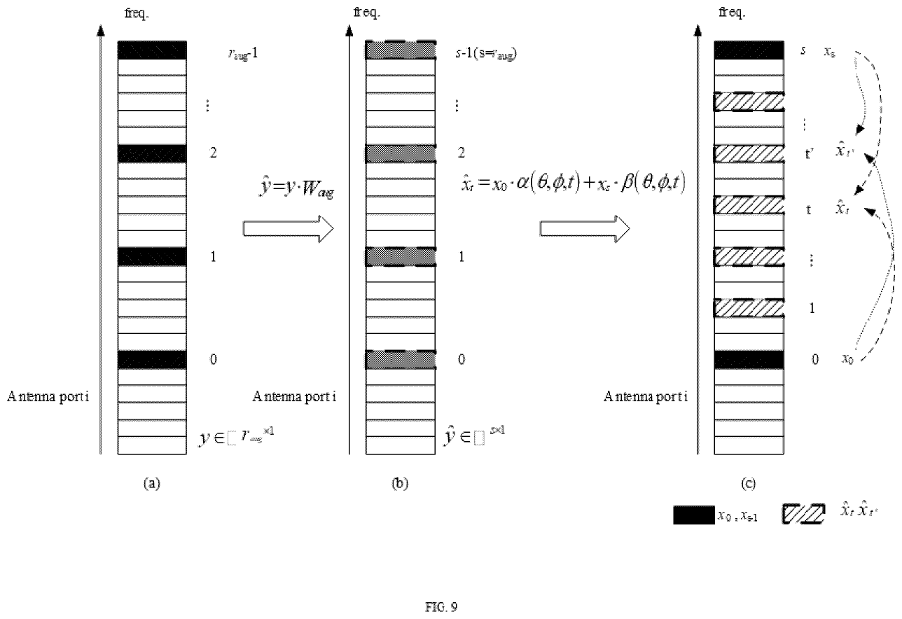

Referring to FIG. 9, an illustration of assistance information (matrix based information and manifold information) used to obtain second channel coefficients are shown. As shown in FIG. 9(a), the transmitting apparatus uses antenna port i to transmit the reference signals on four locations as shown in a black shaded part of FIG. 9(a), and correspondingly, the receiving apparatus receives the reference signals. The receiving apparatus performs channel estimation based on the reference signals to obtain the vector of the first channel coefficients y as shown in FIG. 9(a), and y∈ [symbol] ^{r}^{_{aug}}^{×1}. Assume s=r_{aug}, the receiving apparatus obtains the vector of the intermediate channel coefficients ŷ based on the Form 2 as shown in a black shaded part of FIG. 9(b), and the receiving apparatus obtains the vector of the second channel coefficients \hat{x} based on the Form 5 as shown in a slash shaded part of FIG. 9(c).

The above is a relevant description of the form of the assistance information, the Form (e.g. Form 1-Form 5) mentioned above is an example illustration, and any variant about the above Form, is applicable to the present application embodiment.

In some embodiments, the receiving apparatus receives the assistance information. Correspondingly, the transmitting apparatus transmits the assistance information. Thus, the receiving apparatus could obtain the assistance information, and then obtains the second channel coefficients based on the first channel coefficients and the assistance information. For example, the assistance information could be carried in any one of medium access control-control element (MAC CE), radio resource control (RRC), or control information. If the receiving apparatus is a base station, and the transmitting apparatus is a UE, the control information could be uplink control information (UCI). If the receiving apparatus is a UE, and the transmitting apparatus is a base station, the control information could be downlink control information (DCI).

That the receiving apparatus receives the assistance information is merely an example. For example, the receiving apparatus could determine the assistance information by itself.

In some embodiments, the assistance information could be configured to be any one of: periodical, semi-persistent or aperiodic.

In a possible implementation, the assistance information could be configured to be periodical. In this implementation, the assistance information could be exchanged between the receiving apparatus and the transmitting apparatus regularly according to a period of the assistance information. For example, according to the period of the assistance information, the transmitting apparatus transmits the assistance information periodically, and correspondingly, the receiving apparatus receives the assistance information periodically. The period can be carried in signaling (for example, RRC).

In another possible implementation, the assistance information could be configured to be semi-persistent. In this implementation, the assistance information could be exchanged between the receiving apparatus and the transmitting apparatus regularly according to a period of the assistance information and activate signaling (for example, MAC-CE). For example, the transmitting apparatus transmits the activate signaling to the receiving apparatus, and then the transmitting apparatus transmits the assistance information periodically, and correspondingly, the receiving apparatus receives the assistance information periodically.

In some embodiments, the assistance information could be configured any one of: per type of the reference signals, per resource set of the reference signals, or per antenna port of the reference signals. The per resource set of the reference signals could be replaced with per resource of the reference signals.

In a possible implementation, the assistance information could be configured per antenna port of the reference signals. In this implementation, for an example, in the Example #1, a row dimension of the training channel matrix H could at least include a specific antenna port. For another example, in the Example #2, a row dimension of the training channel matrix [symbol] could at least include a specific antenna port.

In another possible implementation, the assistance information could be configured per resource set of the reference signals. In this implementation, for an example, in the Example #1, the row dimension of the training channel matrix H could at least include all antenna ports that share a specific resource set of the reference signals. For another example, in the Example #2, the row dimension of the training channel matrix [symbol] could at least include all antenna ports that share a specific resource set of the reference signals.

In another possible implementation, the assistance information could be configured per type of the reference signals. In this implementation, for an example, if the reference signals are CSI-RSs, s (that is, the number of resources allocated to the second channel) could include all the CSI-RS Rx antenna ports. For another example, if the reference signals are SRSs, s could include all the SRS Rx antenna ports. For another example, if the reference signals are DMRSs for PDSCH/PDCCH/PUCCH/PUSCH, s could include all the DMRS antenna ports.

Assume the assistance information could be configured per resource set of the reference signals, here are some examples.

Example #A: Resource sets of the reference signals are divided based on difference in time domain.

Assumption is made as follows: based on difference in time domain, the resource sets of the reference signals are divided into resource set #1, resource set #2, and resource set #3.

W_{aug,1} represents assistance information configured for the resource set #1, e.g. 32 ports with (2,8,2) antenna array type (UPA, 2ports in vertical, 8ports in horizontal, and 2 for cross polarization), where W_{aug,1}∈ [symbol] ^{s×r}^{_{aug,1}}. The resource set #1 could be periodical, for example, a periodicity of the resource set #1 is 10 ms.

W_{aug,2} represents assistance information configured for the resource set #2, e.g. 32ports with (2,8,2) antenna array type (UPA, 2ports in vertical, 8ports in horizontal, and 2 for cross polarization), where W_{aug,2}∈ [symbol] ^{s×r}^{_{aug,2}}. The resource set #2 could be periodical, for example, a periodicity of the resource set #2 isl5 ms.

W_{aug,3} represents assistance information configured for the resource set #3, e.g. 32ports with (2,8,2) antenna array type (UPA, 2ports in vertical, 8ports in horizontal, and 2 for cross polarization), where W_{aug,3}∈ [symbol] ^{s×r}^{_{aug,3}}. The resource set #3 could be semi-persistent.

Example #B: Resource sets of the reference signals are divided based on difference in antenna port domain.

Assumption is made as follows: based on difference in antenna port domain, the resource sets of the reference signals are divided into resource set #4.

W_{aug,4} represents assistance information configured for the resource set #4, e.g. 64ports with (4,8,2) antenna array type (UPA, 4ports in vertical, 8ports in horizontal, and 2 for cross polarization), where W_{aug,4}∈ [symbol] ^{s×r}^{_{aug,4}}. The resource set #4 could be periodical, for example, a periodicity of the resource set #4 is 10 ms. Where port #1˜32 could reuse W_{aug,1} in the Example #A, and port #33˜64 could reuse W_{aug,3} in the Example #A.

Example #C: The resource set #1 is used to transmit DMRS, the resource set #2 is used to transmit CSI-RS, and assistance information configured for the resource set #1 could be W_{aug,2} in the Example #A.

In the embodiments of this application, “and/or” describes an association relationship between associated objects and represents that three relationships may exist. For example, A and/or B may represent the following three cases: only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: only A exists, both A and B exist, and only B exists.

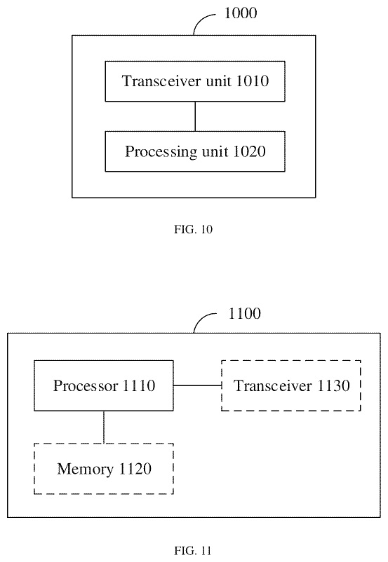

The methods according to embodiments of this application are described above in detail with reference to FIGS. 6-9. The apparatuses provided in embodiments of this application are described below in detail with reference to FIGS. 10-11. Description of apparatus embodiments corresponds to the description of the method embodiments. Therefore, for content that is not described in detail, refer to the foregoing method embodiments. For brevity, details are not described herein again.

The communication method according to the embodiments of this application is described in detail above with reference to FIGS. 6-9, and the transmitting apparatus and the receiving apparatus according to the embodiments of this application will be described in detail below with reference to FIGS. 10-11.

Referring to FIG. 10, a schematic block diagram of a communication apparatus according to an embodiment of this application is shown. The communication apparatus 1000 includes a transceiver unit 1010 and a processing unit 1020. The transceiver unit 1010 may implement a corresponding communication function, and the processing unit 1010 is configured to perform data processing. The transceiver unit 1010 may also be referred to as a communication interface or a communication unit.

In some embodiments, the communication apparatus 1000 may further include a storage unit. The storage unit may be configured to store instructions and/or data. The processing unit 1020 may read instructions and/or data in the storage unit, to enable the communication apparatus to implement the foregoing method embodiments.

The communication apparatus 1000 may be configured to perform actions performed by the transmitting apparatus in the foregoing method embodiments. In this case, the communication apparatus 1000 may be the transmitting apparatus or a component that can be configured in the transmitting apparatus. The transceiver unit 1010 is configured to perform receiving/transmitting-related operations on the transmitting apparatus side in the foregoing method embodiments. The processing unit 1020 is configured to perform processing-related operations on the transmitting apparatus side in the foregoing method embodiments.

Alternatively, the communication apparatus 1000 may be configured to perform actions performed by the receiving apparatus in the foregoing method embodiments. In this case, the communication apparatus 1000 may be the receiving apparatus or a component that can be configured in the receiving apparatus. The transceiver unit 1010 is configured to perform receiving/transmitting-related operations on the receiving apparatus side in the foregoing method embodiments. The processing unit 1020 is configured to perform processing-related operations on the receiving apparatus side in the foregoing method embodiments.

In a design, the communication apparatus 1000 is configured to perform actions performed by the receiving apparatus in the foregoing method embodiments.

In an implementation, the transceiver unit 1010 is configured to receive reference signals; the processing unit 1020 is configured to perform channel estimation based on the reference signals to obtain first channel coefficients corresponding to a first channel; and the processing unit 1020 is configured to obtain second channel coefficients corresponding to a second channel based on the first channel coefficients and assistance information, the assistance information indicates a relationship between the first channel and the second channel.

The communication apparatus 1000 may implement steps or procedures performed by the receiving apparatus in FIGS. 6-9 according to embodiments of this application. The communication apparatus 1000 may include units configured to perform the methods performed by the receiving apparatus in FIGS. 6-9. In addition, the units in the communication apparatus 1000 and the foregoing other operations and/or functions are separately used to implement corresponding procedures in FIGS. 6-9.

In another design, the communication apparatus 1000 is configured to perform actions performed by the transmitting apparatus in the foregoing method embodiments.

In an implementation, the transceiver unit 1010 is configured to transmit reference signals; and the transceiver unit 1010 is configured to transmit assistance information, the assistance information indicates a relationship between a first channel and a second channel, second channel coefficients corresponding to the second channel are determined based on first channel coefficients corresponding to the first channel and the assistance information, the first channel coefficients are obtained based on channel estimation of the first channel with the reference signals.

The communication apparatus 1000 may implement steps or procedures performed by the transmitting apparatus in FIGS. 6-9 according to embodiments of this application. The communication apparatus 1000 may include units configured to perform the methods performed by the transmitting apparatus in FIGS. 6-9. In addition, the units in the communication apparatus 1000 and the foregoing other operations and/or functions are separately used to implement corresponding procedures in FIGS. 6-9.

A specific process in which the units perform the foregoing corresponding steps is described in detail in the foregoing method embodiments. For brevity, details are not described herein again.

Referring to FIG. 11, a schematic block diagram of another communication apparatus according to an embodiment of this application is shown. The communication apparatus 1100 includes a processor 1110. The processor 1110 is coupled to a memory 1120. The memory 1120 is configured to store a computer program or instructions and/or data. The processor 1110 is configured to execute the computer program or instructions and/or data stored in the memory 1120, so that the methods in the foregoing method embodiments are executed.

In some embodiments, the communication apparatus 1100 includes one or more processors 1110.

In an example, as shown in FIG. 11, the communication apparatus 1100 may further include the memory 1120.

In some embodiments, the communication apparatus 1100 may include one or more memories 1120.

In an example, the memory 1120 may be integrated with the processor 1110, or disposed separately from the processor 1110.

In an example, as shown in FIG. 11, the communication apparatus 1100 may further include a transceiver 1130, where the transceiver 1130 is configured to receive and/or transmit a signal. For example, the processor 1110 may be configured to control the transceiver 1130 to receive and/or transmit a signal.

In a solution, the communication apparatus 1100 is configured to perform the operations performed by the transmitting apparatus in the foregoing method embodiments.

For example, the processor 1110 may be configured to perform a processing-related operation performed by the transmitting apparatus in the foregoing method embodiments, and the transceiver 1130 may be configured to perform a receiving/transmitting-related operation performed by the transmitting apparatus in the foregoing method embodiments.

In another solution, the communication apparatus 1100 is configured to perform the operations performed by the receiving apparatus in the foregoing method embodiments.

For example, the processor 1110 may be configured to perform a processing-related operation performed by the receiving apparatus in the foregoing method embodiments, and the transceiver 1130 may be configured to perform a receiving/transmitting-related operation performed by the receiving apparatus in the foregoing method embodiments.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer may be enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

### A Method and Apparatus of Pairing Multiple Users in a Very Large Mimo System

The present application relates to wireless communication in a wireless network.

### DEFINITIONS OF ACRONYMS/ABBREVIATION/INITIALISM

| Full Name | Acronym/Abbreviation/Initialism |
|---|---|
| MIMO | Multiple-In Multiple-Out |
| T-MIMO | Terabit Multiple-In and Multiple-Out |
| NR | New Radio |
| gNB | Next generation base station |
| BS | Base Station |
| UE | User Equipment |
| Tx | Transmitter |
| Rx | Receiver |
| SU | Single User |
| MU | Multiple User |
| RE | Resource Element |
| SVD | Singular Vector Decomposition |
| SNR | Signal-to-Noise Ratio |
| DL | Downlink |
| UL | Uplink |
| TDD | Time Division Duplex |
| FDD | Frequency Division Duplex |
| SRS | Sounding Reference Signal |
| TTI | Time Transmission Interval |
| RF | Radio Frequency |
| IF | Intermediate Frequency |
| MAI | Multiple Access Interference |
| CSI-RS | Channel State Information Reference Signal |
| PMI | Precoding Matrix Index |
| RI | Rank Indicator |
| Pivot-QRD | Pivot QR Decomposition |
| EZF | Eigen-Zero Forcing |
| MSE | Mean Square Error |
| LOS | Line of Sight |
| NLOS | Non Light of Sight |
| RT | Ray Tracing |

### MIMO and MU-MIMO

MIMO system has been widely deployed in modern wireless systems to improve system capacity and bandwidth efficiency by making use of space diversities among antenna ports. For example, on a given subcarrier or RE, a transceiver made of N_{Tx} Tx antenna ports and N_{Rx} Rx antenna ports consists into a N_{Tx}-by-N_{Rx} MIMO channel represented by a N_{Tx}-by-N_{Rx} complex matrix H_{UE,RE}. The N_{Tx}-by-N_{Rx} MIMO channel can be decomposed via SVD: Error! Reference source not found.H_{UE,RE}=Z_{UE,RE}=Z_{UE,RE}S_{UE,RE}V_{UE,RE}^{H}, where Z_{UE,RE} is a N_{Tx}-by-N_{Tx} square orthonormal matrix (s. t. Z_{UE,RE}^{H}Z_{UE,RE}=I), V_{UE,RE} is a R_{Rx}-by-N_{Rx} rectangular diagonal matrix. The rank of H_{UE,RE} is no more than the smaller one between N_{Rx} and N_{Tx}, I.e. r_{UE,RE}=min(N_{Tx},N_{Rx}). Per SVD, if the transmitter applied a precoder matrix Z_{UE,RE}^{H} and the receiver a receiving matrix V_{UE,RE}, the N_{Tx}-by-N_{Rx} MIMO channel would become r_{UE,RE} independent and parallel (orthogonal) subchannels as following:

$${Z}_{UE , RE}^{H} {H}_{UE , RE} {V}_{UE , RE} = ( {Z}_{UE , RE}^{H} {Z}_{UE , RE} ) {S}_{UE , RE} ( {V}_{UE , RE}^{H} {V}_{UE , RE} ) = {S}_{UE , RE}$$

Each sub-channel has a scale value channel response (H_{UE,RE}(i)), i.e. i-th diagonal element of S_{UE,RE} (singular value, H_{UE,RE}(i)=S_{UE,RE}(i, i)). Accordingly, SNR on the i-th sub-channel is defined as

$$\frac{{‖ {H}_{UE , RE} ( i ) ‖}^{2}}{N} , i = 1 , 2 , … , {r}_{UE , RE} .$$

In a wireless system, only the sub-channels whose SNRs are higher than a threshold can be considered as effective sub-channels for transmissions. The remaining (or survival) effective sub-channels are called MIMO flows.

This SNR-based truncation scheme turns a standard SVD into a rank-reduced SVD one by discarding those sub-channels whose SNRs are lower than the threshold(s): H_{UE,RE}≈Z_{UE,RE}S_{UE,RE}V_{UE,RE}^{H} (reduced SVD), where Z_{UE,RE} is a N_{Tx}-by-r_{UE,RE} orthonormal matrix (Z_{UE,RE}^{H}Z_{UE,RE}=I), V_{UE,RE} is r_{UE,RE}-by-N_{Rx} orthonormal matrix (V_{UE,RE}^{H}V_{UE,RE}=I), and S_{UE,RE} is r_{UE,RE}-by-r_{UE,RE} square diagonal matrix. The number of MIMO flows of H_{UE,RE} is r_{UE,RE}≤min (N_{Tx}, N_{Rx}). When the transmitter applied a precoder matrix Z_{UE,RE}^{H} and correspondent receiver applied a receiving matrix V_{UE,RE}, the N_{Tx}-by-N_{Rx} MIMO channel would become:

$${Z}_{UE , RE}^{H} {H}_{UE , RE} {V}_{UE , RE} = ( {Z}_{UE , RE}^{H} {Z}_{UE , RE} ) {S}_{UE , RE} ( {V}_{UE , RE}^{H} {V}_{UE , RE} ) = {S}_{UE , RE}$$

This time S_{UE,RE} is a r_{UE,RE}-by-r_{UE,RE} diagonal matrix.

Mathematically speaking, precoder matrix Z_{UE,RE}^{H} at the transmitter and receiving matrix V_{UE,RE} at the receiver synergy the entire MIMO channel on these remaining sub-channels by linear transformations over the MIMO channel H_{UE,RE}. Its MIMO gain or space diversity gain, indicated by the resultant SNRs

$$\frac{{‖ {H}_{UE , RE} ( i ) ‖}^{2}}{N} , i = 1 , 2 , … , {r}_{UE , RE} ,$$

is attributed to inherent space diversity of MIMO channel between transmitter and receiver, which is related to radio environment. Empirically, radio channels in such complex environment as downtown area would tend to have higher number of MIMO flows than in simpler environment, for high buildings entails more space diversity by more reflectivity.

For higher MIMO gain, wireless systems increases the number of antenna ports, that is, N_{Tx} and N_{Rx}, which hoists the upper-bound of the number of MIMO flows, because of r_{UE,RE}≤min (N_{Tx}, N_{Rx}). But, in reality, r_{UE,RE} is much smaller than its upper-bound, min (N_{Tx}, N_{Rx}). In this context, MU-MIMO was proposed: more than one MIMO channels would be multiplexed by a common precoder W. Imagine that two MIMO channels, H_{UE(1),RE} and H_{UE(2),RE}, on the same RE, are very different from each other; then it is likely to find a common precoder to multiplex both; whereas imagine that two MIMO channels, H_{UE(1),RE} and H_{UE(2),RE}, on the same RE, are almost the same; then it is unlikely to find a common precoder to multiplex both.

Mathematically, this common precoder W is related to precoders Z_{UE(1),RE} and Z_{UE(2),RE}. Concatenate both into one by [symbol] =[Z_{UE(1),RE} Z_{UE(2),RE}] where [symbol] is a N_{Tx}-by-(r_{UE(1),RE}+r_{UE(2),RE}) matrix. Their common precoder is W= [symbol] ( [symbol] ^{H} [symbol] )⁻¹ where W is N_{Tx}-by-(r_{UE(1),RE}+r_{UE(2),RE}) matrix. If Z_{UE(1), RE} and Z_{UE,(2),RE} are orthogonal, [symbol] ^{H} [symbol] approaches an identity matrix, W= [symbol] =[Z_{UE(1),RE} Z_{UE(2),RE}], meaning that the transmitter can continue using precoder matrix Z_{UE(1),RE} for UE-1 and precoder matrix Z_{UE(2),RE} for UE-2 to multiplex on this RE on the same time without MAI. If Z_{UE(1),RE} and Z_{UE(2),RE} are the same, [symbol] ^{H} [symbol] approaches a singular matrix (irreversible) so that no common precoder W is available. These two UEs cannot be paired together. Most practical cases are within the two extreme examples. [symbol] ^{H} [symbol] is neither an identity matrix nor a singular matrix. Transmitter has to compute the common precoders for all the possible combinations and then find the best one. Unfortunately, it is a NP-hard problem. Suppose that a transmitter has 200 candidate receivers. In theory, this transmitter has to make an exhaustive search among

$${\sum }_{i = 2}^{200} ( \begin{matrix}i \\ 200\end{matrix} )$$

times different common precoder W computation for different combinations of receivers. Besides, in order to increase the extent to which [symbol] ^{H} [symbol] approaches an identity matrix and pair more receivers, we usually makes N_{Tx}>>Σᵢr_{UE(i),RE}, motivating wireless systems to adopt more antenna ports or more precisely higher MIMO antenna port ratio between transmitter and receiver (N_{Tx}/N_{Rx}).

After the common precoder W is computed, the transmitter would multiply it to its transmitted signals.

### MU-MIMO Engineering Tradeoffs

For a wireless system, MU-MIMO is usually used in DL in which BS is transmitter and UEs are receivers. MIMO channels of multiple UEs are paired by a common precoder W to multiplex on the same REs (frequency) and the same time durations (timing).

To meet high throughput and system efficiency's end, modern MU-MIMO system has lots of antenna ports across a wide band. For example, in a T-MIMO system (of 6G), it is expected that BS has 1024 antenna ports and UE has 32 antenna ports over 500 MHz bandwidth. The MIMO channel of a UE becomes a three-dimensional tensor (N_{RE}-by-N_{T}x-by-N&).

### Major Tradeoff-1: Assumption on DL/UL Channel Reciprocity

Although MU-MIMO pairing is achieved over the DL channels between one BS and multiple UEs, it is impracticable for each associated UE to report or feedback its DL channel estimation to the BS, because it would result into a huge UL feedback overhead due to the large dimensionality of T-MIMO channel. In TDD system, it is assumed that the DL channel between one BS and one UE can be approximated by the UL channel between the BS and the UE. In 4G and 5G-NR systems, SRS UL channel is specified for the UL channel measurement or estimation for this purpose. SRS UL channel is shared by a number of UEs. These UEs send their own SRS reference signals on the SRS pilot positions so that the BS can estimate their UL MIMO channels respectively. In 5G-NR, the sharing is achieved by coding multiplexing on modulation signals.

### Major Tradeoff-2: Random or Quasi-Random MU-Pairing Implementation

As aforementioned, MU-Pairing is a NP-hard problem. In theory, the optimal pairing is a result from an exhaustive search (computation) on all the possible combinations of the candidate UEs, from 2 of them up to all of them. However, the computation that involves a pseudo-inversion of matrix, [symbol] is too long for a real-time signal processing during one TTI or several TIIs. In particular, when N_{Tx} is more than hundreds or even thousands and pairing 10 or 20 UEs, the pseudo-inversion of matrix [symbol] could become computation-wisely forbidden for most hardware implementation in several TTIs. Due to the complexity and latency limitations, there is nearly no exhaustive computation to search the best pairing scheme in a practical implementation. Instead, some random or quasi-random selection of a given number of the paired UEs from a big pool of candidates is firstly conducted into [symbol] and then followed by a common precoder matrix computation W= [symbol] ( [symbol] ^{H} [symbol] )⁻¹. Empirically, the selection may consider the positions of the candidate UEs. For example, an empirical selection algorithm may tend to choose the paired UEs far from each other, because it is more likely for these UEs to have orthogonal MIMO channels. For example, the number of the paired is simply given by empirical experience or hardware limitation.

Strictly speaking, the tradeoff doesn't realize the pairing but only compute the precoder matrix W from whichever reversible [symbol] ^{H} [symbol] .

Assistance information of LTE and 5G-NR RS

3GPP has introduced Quasi-Colocation (QCL) concept in LTE and 5G-NR to help the UE with channel estimation, frequency offset error estimation and synchronization procedures. For example, if UE knows that the radio channels corresponding to two different antenna ports is QCL in terms of Doppler shift, then UE can determine Doppler shift for one antenna port and then apply the result on both antenna ports for channel estimation. This avoids the UE to calculate doppler for both antenna port separately.

The antenna port can be used for transmission of a physical channel or signal. The antenna port can be defined so that the channel over which a symbol on the antenna port is conveyed can be inferred from the channel over which another symbol on the same antenna port is conveyed. Different antenna ports can correspond to different reference signals, which can be used for channel estimation and processing of the physical channel transmitted on the same antenna ports. Antenna ports that correspond to different reference signals may be located at the same location, or different locations. Each channel of a signal from differently located antenna ports can have substantially different large scale properties due to the different location, different distance from a UE, different signal paths, and so forth. However, antenna ports that are located at different locations may still have similar large scale properties if the distance between the ports is not substantial. These antenna ports can be assumed to have the same large scale properties. They are referred to as being quasi co-located. Two antenna ports can be quasi co-located if the large-scale properties of the channel over which a symbol on one antenna port is conveyed can be inferred from the large-scale properties of the channel over which a symbol on the other antenna port is conveyed.

5G NR have support for multi-antenna transmission, beam-forming, and simultaneous transmission from multiple geographically separates sites (CoMP). In such cases, the channels of different antenna ports relevant for a UE may differ even in terms of radio channel properties and QCL antenna port may be geographically separated. Therefore, QCL information actually is a type of assistance information for channel estimation, which utilize the commonality of channel properties among different antenna ports.

### Non-Uniform Pilot Placement Patterns

Both 5G-NR SRS UL Channels and CSI-RS DL channels employs uniform pilot placement patterns, partly because uniform pilot placement patterns are among the safest method to ensure channel estimation performance in particular with little prior-knowledge about the current channel, partly because they are easy to be described, standardized, and aligned (configured) across transceiver. However, uniform pilot placement patterns are one of the lowest efficient patterns. Its density must be designed for the worst case in statistics, which is rare in practice. In another word, uniform pilot placement patterns specified in the 5G-NR standard may as well be over-designed in most practical cases.

In 5G-NR, average density of its uniform pilot placement patterns is about 7%-17% of its radio resource to be used for pilots or reference signals. For example, every RB (made of 12 REs) has one reference signals, resulting into 8.33% (˜1/12) overhead for pilots. If the same uniform density were to be employed in TMIMO, the overhead would be too huge to be processed. At least, it would be impossible for these UEs on the edge to feedback huge CSIs.

In theory, non-uniform pilot placement patterns based on prior-knowledge about distribution of a channel would use much less pilot overhead. First of all, how is prior-knowledge represented and found? It is invented that the prior-knowledge about a high-dimensional signal space (MIMO channel can be considered as high-dimensional signal space) can be represented by an orthonormal basis N_{dim}-by-rₑₙᵥ U¹ (s.t. U^{H}U=I). N_{dim} is the total dimension after vectorized. For example, the total dimension of a MIMO channel of N_{RE}-by-N_{Tx}-by-N_{Rx} is N_{dim}=N_{RE}N_{Rx}N_{Rx}. rₑₙᵥ is related to how complicated the prior-knowledge contain. In mathematic, rₑₙᵥ is the number of principal components of the prior knowledge.

The radio channel properties which may be common across the antenna ports includes Doppler spread/shift, average delay, delay spread, average gain and spatial receiver parameters. This properties are known as “large-scale properties”. A short definition of each is given below
Doppler Shift: Doppler shift is a shift in the frequency of the radio signal relative to motion of the receiver. E.g. gNB transmits a radio signal of a frequency “X” however the receiver (UE) is in mobility traveling away from the gNB so that same radio signal due to the distance of the UE by the time it reaches the UE the frequency is changed to “Y”, this phenomenon is known as Doppler shift. A real life example is the sound of a speeding train that comes close and speeds away to person standing on the platform, is called Doppler shift of sound wave.
Doppler Spread: Doppler Spread is known as fading rate, difference between the signal frequency at the Tx & Rx with respect to time is called Doppler spread. E.g. The rate at which the train sound changes over time is called Doppler spread.
Average Delay: When signal is transmitted from multiple antenna, it reaches to receiver through multiple path reflect from surrounding clutter. In multi path scenario the average time taken to receive all the Multi path components at the receiver is known as Average Delay.
Delay Spread: Difference between the time of arrival of the earliest significant multi path component i.e. typically the line of sight (LOS) component and the time of arrival of the last multi path component is known as Delay spread.
Spatial Receiver Parameter: Spatial Receiver Parameter are refers to Beam Forming properties of Downlink received signal like dominant Angle of Arrival, average Angle of Arrival at UE.
Following table mentions 5G NR QCL Types.

| QCL type | Description |
|---|---|
| Type-A | {Doppler shift, Doppler spread, average delay, delay |
| | spread} |
| Type-B | {Doppler shift, Doppler spread} |
| Type-C | {Doppler shift, average delay} |
| Type-D | {Spatial Rx parameter} |

The large-scale properties of the channel can include one or more of: average delay, delay spread, Doppler shift, Doppler spread, and average gain. The average delay can include the first-order statistics for the time property of a channel. The delay spread can include the second-order statistics for the time property of the channel. The Doppler shift can include the first-order statistics for the frequency properties of a channel. The Doppler spread can include the second-order statistics for the frequency properties of a channel. The average gain can include the first-order statistics for the amplitude properties of the channel. The large-scale properties estimated on antenna ports of reference signals can be used to parametrize the channel estimator and compensate for possible time and frequency errors when deriving channel state information (CSI) feedback or when performing demodulation.

### Problem and Objective

Assistance Information of LTE and 5G-NR RS, e.g. QCL

The major disadvantage is that it utilize the commonality of different antenna ports only, other than the correlation among different antenna ports, which could help to improve channel estimation accuracy on top of reference signals.

This application focuses on define a new type assistance information for channel estimation on top of RS, especially for RS transmitting in MIMO system.

### Overview

The new type of assistance information for channel estimation is associated with a reference signal and needs to be exchanged between BS and UE.
The assisted information could be
   Matrix based information
   Vector based information
   Tensor based information
   Manifold information
   Hybrid matrix/tensor/vector and manifold information
The assisted information could be used for obtaining the target channel coefficients by linear or non-linear transformation on top of the measured channel coefficients of the associated reference signal
   The dimension of the target channel coefficients could be larger or equal to the dimension of the measured channel coefficients
The associated reference signal could be
   CSI-RS, DMRS for PDSCH/PUSCH, SRS etc.
The assisted information could be configured Per RS type or per RS resource set or Per RS port
   Periodical, semi-persistent or aperiodic
The assisted information could be
   Tx ports or Rx ports only in time/frequency domain
      Tx and Rx ports in time/frequency domain.

The current application can be used to solve the channel estimation problem for T-MIMO system where there is large number for transmitter and receiver antenna ports and large bandwidth. The same method can be also applied to normal MIMO system (for example, 5G MIMO system), or even single antenna system.

By using the current invention, the following characters will show up in the system:
Require assistance information for channel estimation, which is obtained from the prior-knowledge of channel status of the target environment.
   The accuracy of channel estimation will be improved based on the assistance information proposed in this idea. The assistance information for channel estimation could also enable a far sparse pilot pattern(s) than traditional pilot pattern(s) (5G NR pilot design) and it could be non-uniformly distributed along time-frequency-spatial resources.

### EMBODIMENTS

By using the current application, the following characters will show up in the system:

### 1. Embodiment 1 (Matrix Based Assistance Information)

### 1.1 Detailed Description of Embodiment

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   If the associated RS is CSI-RS or DM-RS for PDSCH, m can at least include Rx ports at UE side;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel matrix H represents downlink raw channel;
   DMRS for PDSCH. Then the training channel matrix represents downlink equivalent channel (the channel with precoding);
The assisted information could be configured
   Per RS port. Then the row dimension of the training channel matrix H will at least include the specific antenna port.
   Per RS resource set. Then the row dimension of the training channel matrix H will at least include all the antenna ports that share the same resource set.
      Example #1: divided RS resource sets based on difference in time domain.
         W_{aug,1}∈ [symbol] ^{s×r}^{_{aug,1}} represents a periodical CSI-RS resource set #1, e.g. 32ports with (2,8,2) antenna array type (UPA, 2ports in vertical, 8ports in horizontal, and 2 for cross polarization) and periodicity=10 ms;
         W_{aug,2}∈ [symbol] ^{s×r}^{_{aug,2}} represents a periodical CSI-RS resource set #2, e.g. 32ports with (2,8,2) antenna array type (UPA, 2ports in vertical, 8ports in horizontal, and 2 for cross polarization) and periodicity=15 ms;
         W_{aug,3}∈ [symbol] ^{s×r}^{_{aug,3}} represents a semi-persistent CSI-RS resource set #3, e.g. 32ports with (2,8,2) antenna array type (UPA, 2ports in vertical, 8ports in horizontal, and 2 for cross polarization);
      Example #2: divided RS resource sets based on difference in antenna port domain.
         W_{aug,4}∈ [symbol] ^{s×r}^{_{aug,4}} represents a periodical CSI-RS resource set #4, e.g. 64ports with (4,8,2) antenna array type (UPA, 4ports in vertical, 8ports in horizontal, and 2 for cross polarization) and periodicity=10 ms; where,
         port #1˜32 reuse W_{aug,1} ∈ [symbol] ^{s×r}^{_{aug,1}} in example #1;
         port #33˜64 reuse W_{aug,3}∈ [symbol] ^{s×r}^{_{aug,3}} in example #1;
      Example #3:
         gNB configure DM-RS for PDSCH resource set #1, which reuse the assistance information for CSI-RS resource set #2 in example #1.
   Per RS type. Then the row dimension of the training channel matrix H will at least include all the antenna ports.
      If the associated RS is CSI-RS, s can include all the CSI-RS Tx ports;
      If the associated RS is DM-RS for PDSCH, s can include all the DM-RS ports;
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx ports only in time/frequency domain.
      If the associated RS is CSI-RS, then the Tx ports refer to the transmit antenna port at gNB side.
      If the associated RS is DM-RS for PDSCH, then Tx ports refer to the DM-RS antenna port.

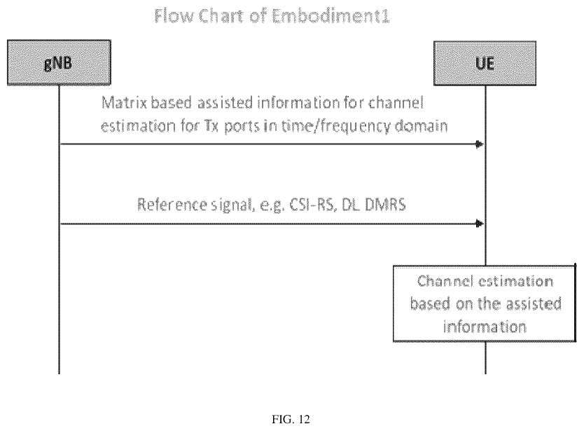

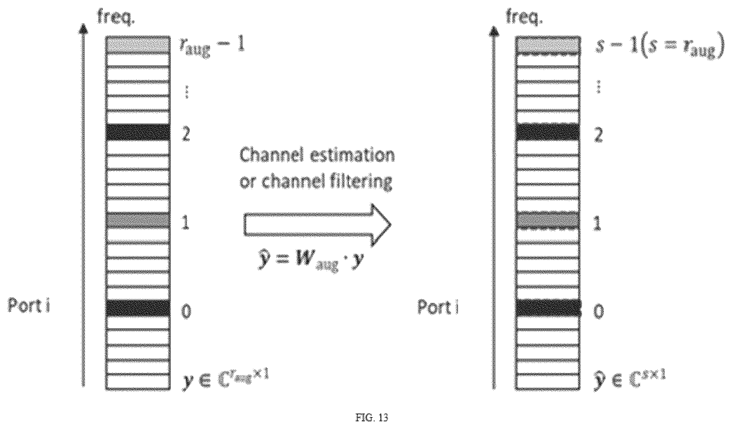

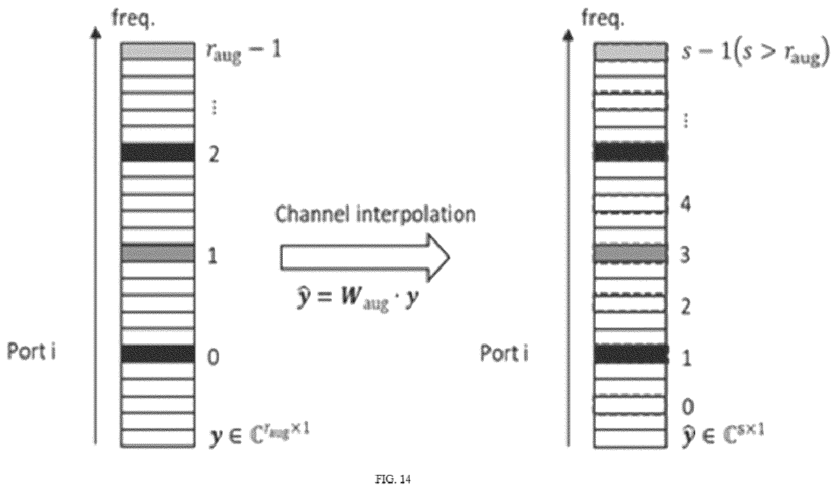

FIG. 12 is a flow chart of embodiment 1. FIG. 13 and FIG. 14 are illustration of using matrix based assisted information of channel estimation. FIG. 13 is an illustration of channel estimation or channel filtering, and FIG. 14 is an illustration of channel interpolation.

### 1.2 the Technical Benefit(s)/Advantage(s) of Embodiment

The matrix based assisted information for channel estimation on top of the sparse RS for CSI-RS and/or DM-RS for PDSCH could be used for obtaining the target channel coefficients by linear transformation on top of the measured channel coefficients of the associated reference signal. It can be theoretically guaranteed a high accuracy for channel estimation.

### 2. Embodiment 2 (Tensor Based Assistance Information)

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be tensor based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let [symbol] ∈ [symbol] ^{s×n×m} be the training channel tensor. The physical meaning [symbol] , n and m depend on the associated RS and the specific schemes.
   If the associated RS is CSI-RS or DM-RS for PDSCH, m can at least include Rx ports at UE side;
   If the associated RS is DM-RS for PDSCH, n can at least include the MU UEs;
   Do matrix decomposition HOSVD on [symbol] , which expresses as [symbol] =g₀×₁ U₀×₂ S₀×₃ V₀; where [symbol]
   0∈ [symbol] ^{s′×n′×m′} represents the core channel tensor; and s′≤s.
   Then select the TOP r column vectors of U₀∈ [symbol] ^{s×s′} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means rug r.
s represents the number of resources allocated to the target physical channel and or physical signal;
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel tensor [symbol] represents downlink raw channel;
   DMRS for PDSCH. Then the training channel matrix represents downlink equivalent channel (the channel with precoding);
The assisted information could be configured
   Per RS port. Then the row dimension of the training channel tensor [symbol] will at least include the specific antenna port.
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx ports only in time/frequency domain.
      If the associated RS is CSI-RS, then the Tx ports refer to the transmit antenna port at gNB side.
      If the associated RS is DM-RS for PDSCH, then Tx ports refer to the DM-RS antenna port.

FIG. 15 is a flow chart of embodiment 2.

### 3. Embodiment 3 (Manifold Based Assistance Information)

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be manifold based information.
   Assume the assisted information expressed as parameter θ and φ, where
      Let x₀ ∈ [symbol] ^{k×1} and xₛ₋₁∈ [symbol] ^{k×1} be the known channel vectors containing the measured channel coefficient on the pilot positions;

$$θ = acos ( \frac{\vert {x}_{0}^{H} \cdot {x}_{s - 1} \vert}{\vert {x}_{0} \vert \cdot \vert {x}_{s - 1} \vert} )$$

be the subspace angle between x₀ and xₛ₋₁; the function “acos” is the arcus cosine function; the upper notation “H” represents the matrix operation of conjugate transposition.

$$ϕ = atan ( Im ( \frac{{x}_{0}^{H} \cdot {x}_{s - 1}}{\vert {x}_{0} \vert \cdot \vert {x}_{s - 1} \vert} ) / Re ( \frac{{x}_{0}^{H} \cdot {x}_{s - 1}}{\vert {x}_{0} \vert \cdot \vert {x}_{s - 1} \vert} ) ) ;$$

the function “atan” is the arcus tangent function; the functions “Re” and “Im” represent taking the real and imaginary part of a complex number respectively.
k can be the number of Rx ports at UE side;
The assisted information could be used for obtaining the target channel coefficients by linear transformation on top of the measured channel coefficients of the associated reference signal.
   The procedure of using measured channel coefficients on the pilot positions to obtain the target channel coefficients expressed as \hat{x}ₜ=x₀·α(θ, φ, t)+xₛ₋₁·β(θ, φ, t), where
      \hat{x}ₜ∈ [symbol] ^{k×1} represents the vector containing the target channel coefficients.

$$α ( θ , ϕ , t ) = ( cos ( \frac{t + 1}{s} \cdot θ ) - cos ( θ ) \cdot \frac{sin ( \frac{t + 1}{s} \cdot θ )}{sin ( θ )} ) \cdot {e}^{+ 1 j ϕ \cdot \frac{t + 1}{s}} ;$$

the function “sin” is the arcus sine function; the notation “1j” represents the imaginary unit.

$$β ( θ , ϕ , t ) = \frac{sin ( \frac{t + 1}{s} \cdot θ )}{sin ( θ )} \cdot {e}^{+ 1 j ϕ \cdot ( \frac{t + 1}{s} - 1 )} ;$$

t represents the relative position of \hat{x}ₜ in between x₀ and xₛ₋₁;
The associated reference signal could be
   CSI-RS. Then the channel vectors x₀ and xₛ₋₁ represent downlink raw channel vectors;
   DMRS for PDSCH. Then the channel vectors x₀ and xₛ₋₁ represent downlink equivalent channel vectors (the channel with precoding);
The assisted information could be configured
   Per RS port.
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx ports only in time/frequency domain.
If the associated RS is CSI-RS, then the Tx ports refer to the transmit antenna port at gNB side.
If the associated RS is DM-RS for PDSCH, then Tx ports refer to the DM-RS antenna port.

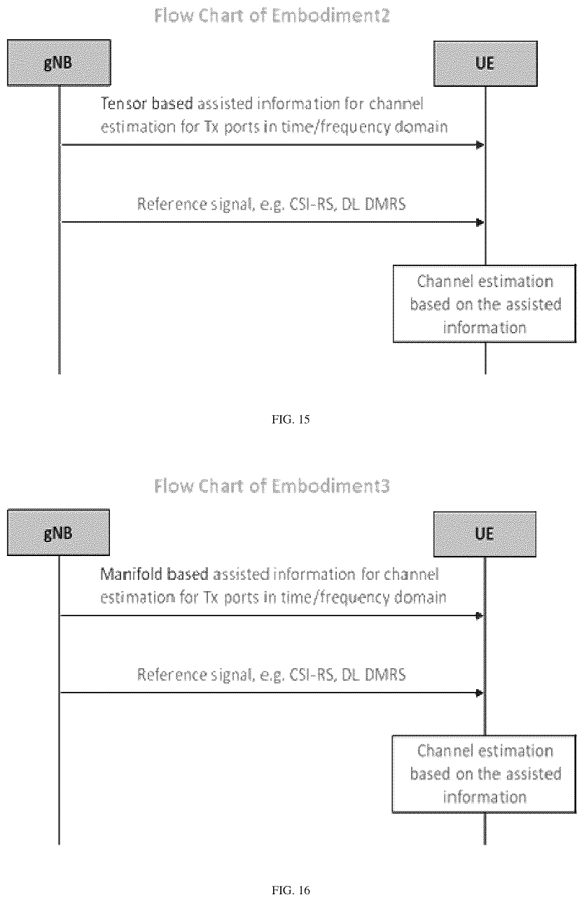

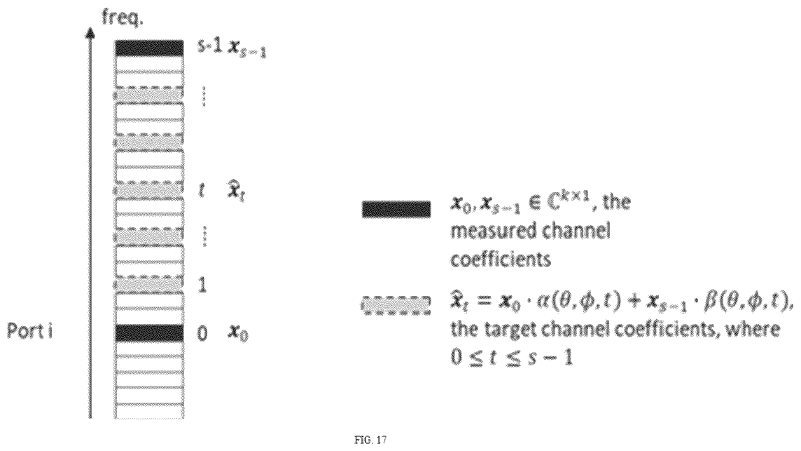

FIG. 16 is a flow chart of embodiment 3. FIG. 17 is an illustration of using manifold based assisted information of channel estimation.

### 4. Embodiment 4 (Matrix and Manifold Based Assistance Information)

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be a combination of both matrix based and manifold based information.
   Assume the 1st part of assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   If the associated RS is CSI-RS or DM-RS for PDSCH, m can at least include Rx ports at UE side;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
One of the feasible metrics: r is selected so that the accumulated value of the TOP r singular values of the channel matrix is no less than the given threshold.
The other one of the feasible metrics: r is selected so that the resource density is no larger than the given threshold.
r_{aug} represents the augment number of resources allocated to the RS;
The index set of resources allocated to the RS is a subset to the index set of augment resources allocated to the RS, which means r_{aug}≥r.
s represents the number of resources allocated to the target physical channel and or physical signal;
Assume the 2nd part of assisted information expressed as parameter θ and φ, where
   Let x₀∈ [symbol] ^{k×1} and xₛ₋₁∈ [symbol] ^{k×1} be the known channel vectors containing the measured channel coefficient on the pilot positions;

$$θ = acos ( \frac{\vert {x}_{0}^{H} \cdot {x}_{s - 1} \vert}{\vert {x}_{0} \vert \cdot \vert {x}_{s - 1} \vert} )$$

be the subspace angle between x₀ and xₛ₋₁; the function “acos” is the arcus cosine function; the upper notation “H” represents the matrix operation of conjugate transposition.

$$ϕ = atan ( Im ( \frac{{x}_{0}^{H} \cdot {x}_{s - 1}}{\vert {x}_{0} \vert \cdot \vert {x}_{s - 1} \vert} ) / Re ( \frac{{x}_{0}^{H} \cdot {x}_{s - 1}}{\vert {x}_{0} \vert \cdot \vert {x}_{s - 1} \vert} ) ) ;$$

the function “atan” is the arcus tangent function; the functions “Re” and “Im” represent taking the real and imaginary part of a complex number respectively.
k can be the number of Rx ports at UE side;
The assisted information could be used for obtaining the target channel coefficients by linear transformation on top of the measured channel coefficients of the associated reference signal.
   The 1st part of the procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s=r_{aug}≥r.
         The dimension of the target channel coefficients could be equal to the dimension of the measured channel coefficients n=r_{aug}, which means channel estimation or channel filtering.
   The 2nd part of the procedure of using measured channel coefficients on the pilot positions to obtain the target channel coefficients expressed as \hat{x}ₜ=x₀·α(θ, φ, t)+xₛ₋₁·β(θ, φ, t), where
      \hat{x}ₜ∈ [symbol] ^{k×1} represents the vector containing the target channel coefficients.
         x₀=[ŷ₀(0) . . . ŷₖ₋₁(0)]^{T}, the ŷₖ₋₁(0) means the 1st element of ŷₖ₋₁∈ [symbol] ^{s×1}, where the lower notation “k−1” means the k-th Rx ports at UE side.
         xₛ₋₁=[ŷ₀(s−1) . . . ŷₖ₋₁(s−1)]^{T}, the ŷₖ₋₁(s−1) means the s-th element of ŷₖ₋₁∈ [symbol] ^{s×1}, where the lower notation “k−1” means the k-th Rx ports at UE side.

$$α ( θ , ϕ , t ) = ( cos ( \frac{t + 1}{s} \cdot θ ) - cos ( θ ) \cdot \frac{sin ( \frac{t + 1}{s} \cdot θ )}{sin ( θ )} ) \cdot {e}^{+ 1 j ϕ \cdot \frac{t + 1}{s}} ;$$

the function “sin” is the arcus sine function; the notation “1j” represents the imaginary unit.

$$β ( θ , ϕ , t ) = \frac{sin ( \frac{t + 1}{s} \cdot θ )}{sin ( θ )} \cdot {e}^{+ 1 j ϕ \cdot ( \frac{t + 1}{s} - 1 )} ;$$

t represents the relative position of \hat{x}ₜ in between x₀ and xₛ₋₁;
The associated reference signal could be
   CSI-RS. Then the training channel matrix H represents downlink raw channel; and the channel vectors x₀ and xₛ₋₁ represent downlink raw channel vectors;
   DMRS for PDSCH. Then the training channel matrix represents downlink equivalent channel (the channel with precoding) and the channel vectors x₀ and xₛ₋₁ represent downlink equivalent channel vectors (the channel with precoding);
The assisted information could be configured
   Per RS port. Then the row dimension of the training channel matrix H will at least include the specific antenna port.
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx ports only in time/frequency domain.
      If the associated RS is CSI-RS, then the Tx ports refer to the transmit antenna port at gNB side.
      If the associated RS is DM-RS for PDSCH, then Tx ports refer to the DM-RS antenna port.

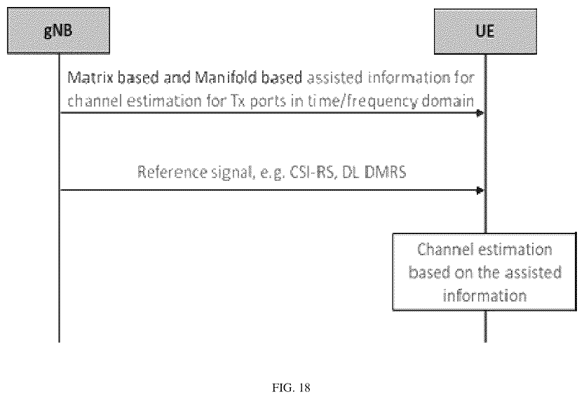

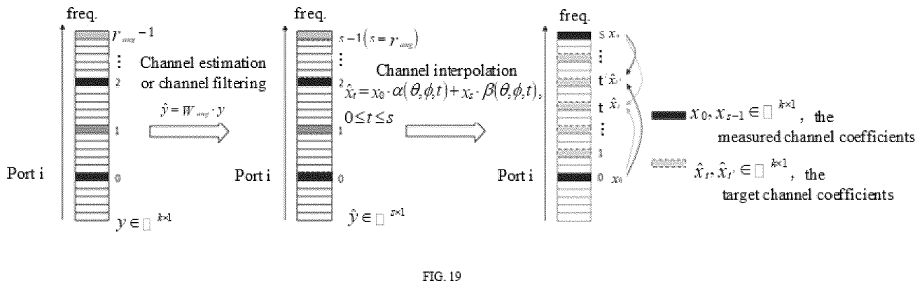

FIG. 18 is a flow chart of embodiment 4. FIG. 19 is an illustration of using both matrix based and manifold based assisted information of channel estimation.

### 4.1 the Technical Benefit(s)/Advantage(s) of Embodiment

The manifold based assisted information for channel estimation on top of the sparse RS for CSI-RS and/or DM-RS for PDSCH could be used for obtaining the target channel coefficients by linear transformation on top of the measured channel coefficients of the associated reference signal. It can be theoretically guaranteed a high accuracy for channel estimation.

### 5. Embodiment 5 (Feedback Assistance Information)

### 5.1 Detailed Description of Embodiment

A new type of assisted information for channel estimation, which is associated with a reference signal (RS) and needs to be exchanged between gNB and UE.
In this embodiment, a new feedback information to assist channel estimation for reference signal, which could be configured by UE.
   The assisted information for channel estimation could be used for obtaining/deriving the target channel coefficients at gNB side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   If the associated RS is SRS or DM-RS for PUSCH/PUCCH, m can at least include Rx ports at BS side;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   SRS. Then the training channel matrix H represents uplink raw channel;
   DM-RS for PUSCH/PUCCH. Then the training channel matrix represents uplink equivalent channel (the channel with precoding);
The assisted information could be configured
   Per RS port. Then the row dimension of the training channel matrix H will at least include the specific antenna port.
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI/UCI signaling.
The assisted information could be
   Rx ports only in time/frequency domain.
      If the associated RS is SRS, then the Rx ports refer to the transmit antenna port at UE side.
      If the associated RS is DM-RS for PUSCH/PUCCH, then Rx ports refer to the DM-RS antenna port for PUSCH/PUCCH.
   Tx & Rx ports in time/frequency domain.
      If the associated RS is SRS, then the Rx ports refer to the transmit antenna port at UE side and the Tx ports refer to the receive antenna port at BS side.
      If the associated RS is DM-RS for PUSCH/PUCCH, then Rx ports refer to the DM-RS antenna port for PUSCH/PUCCH and the Tx ports refer to the receive antenna port at BS side.

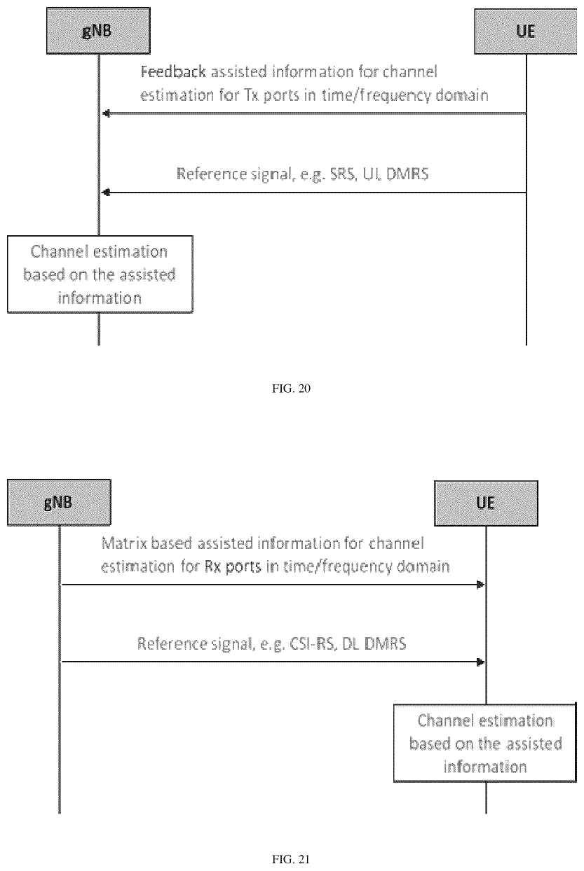

FIG. 20 is a flow chart of embodiment 5.

### 5.2 the Technical Benefit(s)/Advantage(s) of Embodiment

The manifold based assisted information for channel estimation on top of the sparse RS for CSI-RS and/or DM-RS for PDSCH could be used for obtaining the target channel coefficients by linear transformation on top of the measured channel coefficients of the associated reference signal. It can be theoretically guaranteed a high accuracy for channel estimation.

### 6. Embodiment 6

### 6.1 Detailed Description of Embodiment

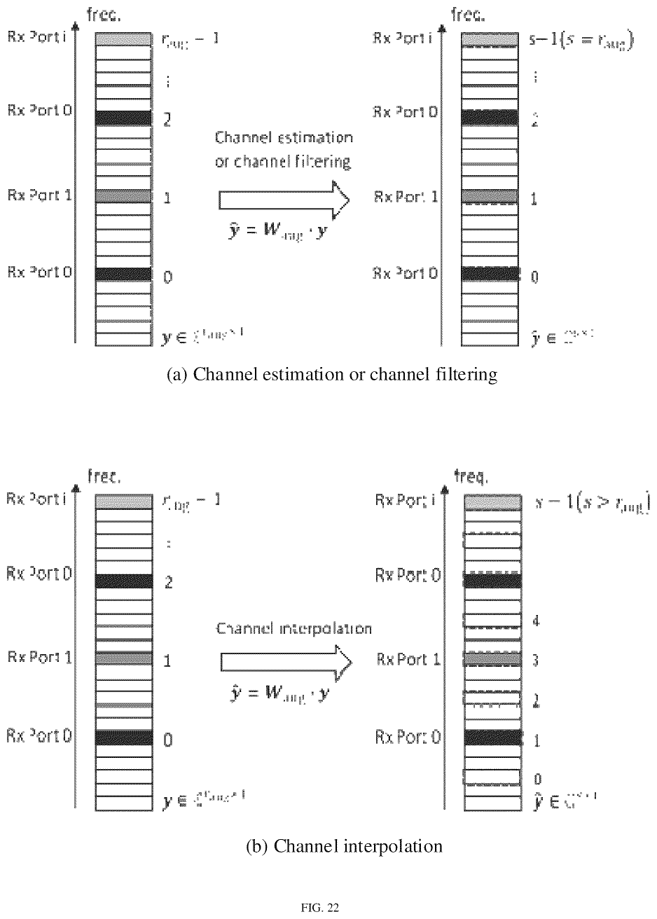

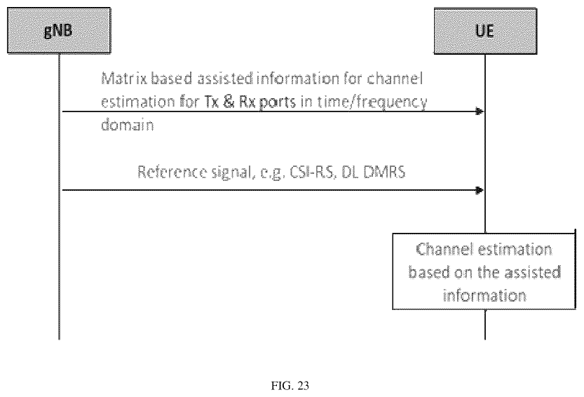

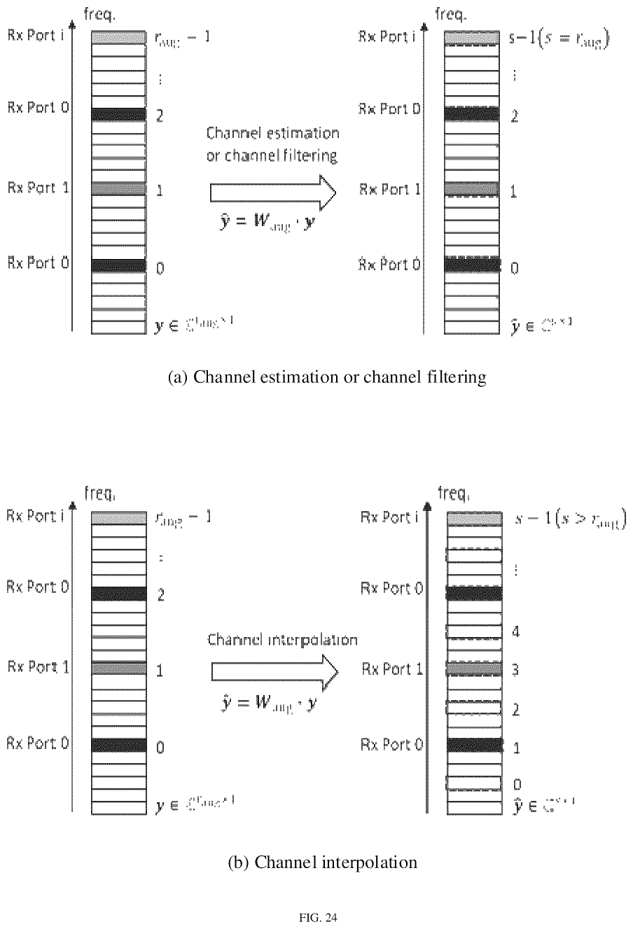

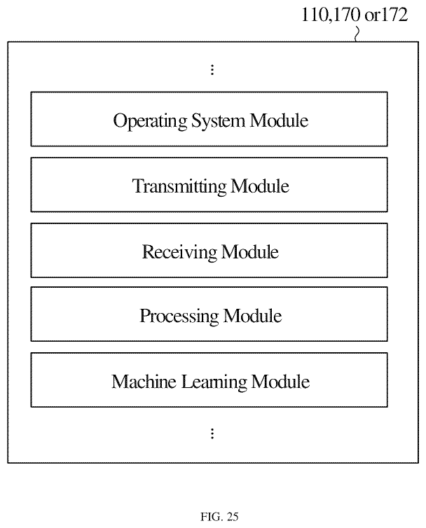

FIG. 21 is a flow chart of embodiment 6-1. FIG. 22 is an illustration of the assisted information of channel estimation containing Rx port only in time/frequency domain.

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   In this embodiment, if the associated RS is CSI-RS or DM-RS for PDSCH, m can at least include RS ports;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
   In this embodiment, s can include the Rx ports.
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel matrix H represents downlink raw channel;
   DMRS for PDSCH. Then the training channel matrix represents downlink equivalent channel (the channel with precoding);
The assisted information could be configured
   Per RS type. Then the row dimension of the training channel matrix H will at least include the specific antenna port.
      If the associated RS is CSI-RS, s can include all the CSI-RS Tx ports;
      If the associated RS is DM-RS for PDSCH, s can include all the DM-RS ports;
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Rx ports only in time/frequency domain.
      If the associated RS is CSI-RS or DM-RS for PDSCH, then the Rx ports refer to the receive antenna port at UE side.

### 6.2 the Technical Benefit(s)/Advantage(s) of Embodiment

The matrix based assisted information for channel estimation on top of the sparse RS for CSI-RS and/or DM-RS for PDSCH could be used for obtaining the target channel coefficients by linear transformation on top of the measured channel coefficients of the associated reference signal. It can be theoretically guaranteed a high accuracy for channel estimation.

### 7. Embodiment 7

### 7.1 Detailed Description of Embodiment

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   In this embodiment, if the associated RS is SRS or DM-RS for PUSCH/PUCCH, m can at least include RS ports;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
   In this embodiment, s can include the Rx ports.
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel matrix H represents downlink raw channel;
   DMRS for PDSCH. Then the training channel matrix represents downlink equivalent channel (the channel with precoding);
The assisted information could be configured
   Per RS type. Then the row dimension of the training channel matrix H will at least include the specific antenna port.
      If the associated RS is CSI-RS, s can include all the CSI-RS Tx ports;
      If the associated RS is DM-RS for PDSCH, s can include all the DM-RS ports;
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Rx ports only in time/frequency domain.
      If the associated RS is CSI-RS or DM-RS for PDSCH, then the Rx ports refer to the receive antenna port at gNB side.

### 7.2 the Technical Benefit(s)/Advantage(s) of Embodiment

The matrix based assisted information for channel estimation on top of the sparse RS for SRS and/or DM-RS for PUSCH/PUCCH could be used for obtaining the target channel coefficients by linear transformation on top of the measured channel coefficients of the associated reference signal. It can be theoretically guaranteed a high accuracy for channel estimation.

### 8. Embodiment 8

### 8.1 Detailed Description of Embodiment

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   In this embodiment, if the associated RS is CSI-RS or DM-RS for PDSCH, m can at least include RS ports;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
   In this embodiment, s can include the Rx ports.
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel matrix H represents downlink raw channel;
   DMRS for PDSCH. Then the training channel matrix represents downlink equivalent channel (the channel with precoding);
The assisted information could be configured
   Per RS type. Then the row dimension of the training channel matrix H will at least include the specific antenna port.
      If the associated RS is CSI-RS, s can include all the CSI-RS Tx ports;
      If the associated RS is DM-RS for PDSCH, s can include all the DM-RS ports;
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx & Rx ports in time/frequency domain.
      If the associated RS is CSI-RS, then the Tx ports refer to the transmit antenna port at gNB side and the Rx ports refer to the receive antenna port at UE side.
      If the associated RS is DM-RS for PDSCH, then Tx ports refer to the DM-RS antenna port for PDSCH and the Rx ports refer to the receive antenna port at UE side.

### 8.2 the Technical Benefit(s)/Advantage(s) of Embodiment

The matrix based assisted information for channel estimation on top of the sparse RS for CSI-RS and/or DM-RS for PDSCH could be used for obtaining the target channel coefficients by linear transformation on top of the measured channel coefficients of the associated reference signal. It can be theoretically guaranteed a high accuracy for channel estimation.

### 9. Embodiment 9

Embodiment 9 is as follows.
This embodiment describes a scheme for the scenario that different both Tx & Rx port groups or both Tx & Rx ports can be indicated with specific assisted information of channel estimation (the different channel response may be caused by physical reasons, e.g., polarization antenna ports). The benefit can be further reducing the RS overhead as there is no need to enforce a common pattern across different Tx & Rx ports pair.

It should be noted that if the assisted information is manifold based or a combination of matrix based and manifold based, the method in this embodiment also works.

It also should be noted that if the assisted information is configured per RS resource set or per RS port, the method in this embodiment also works.

### 9.1 Detailed Description of Embodiment

A new type of assisted information for channel estimation, which is associated with a reference signal (RS) and needs to be exchanged between gNB and UE.
In this embodiment, a new signaling to assist channel estimation for reference signal, which could be configured by gNB.
   The assisted information for channel estimation could be used for obtaining/deriving the target channel coefficients at UE side.
The assisted information could be matrix based information.
   Assume the assisted information expressed as

$${W}_{aug} = U \cdot {θ}_{aug}^{- 1} ∈ {ℂ}^{s \times {r}_{aug}} ,$$

where
matrix U∈ [symbol] ^{s×r} represents the channel space basis;
   One of the feasible methods to obtain matrix U:
   let H∈ [symbol] ^{s×m} be the training channel matrix. The physical meaning of H and m depend on the associated RS and the specific schemes.
   In this embodiment, if the associated RS is CSI-RS or DM-RS for PDSCH, m can at least include RS ports;
   Do matrix decomposition SVD on H, which expresses as

$$H = {U}_{0} \cdot {\sum }_{0} \cdot {V}_{0}^{H} ;$$

Without losing generality, assume s≥m. Then select the TOP r column vectors of U₀∈ [symbol] ^{s×m} and form the matrix U∈ [symbol] ^{s×r}.
matrix θ_{aug}=P_{aug}·U∈ [symbol] ^{r}^{_{aug}}^{×r} represents the reduced channel space basis; and the upper notation “−1” represents the operation of matrix pseudoinverse;
matrix P_{aug}∈ [symbol] ^{r}^{_{aug}}^{×s} represents the augment pilot position matrix based on pivot position on U^{H}; and the upper notation “H” represents the matrix operation of conjugate transposition;
r represents the number of resources allocated to the RS;
   One of the feasible metrics: r is selected so that the accumulated value of the TOP r singular values of the channel matrix is no less than the given threshold.
   The other one of the feasible metrics: r is selected so that the resource density is no larger than the given threshold.
r_{aug} represents the augment number of resources allocated to the RS;
   The index set of resources allocated to the RS is a subset to the index set of augment resources allocated to the RS, which means r_{aug}≥r.
s represents the number of resources allocated to the target physical channel and or physical signal;
   In this embodiment, s can include the Rx ports.
The assisted information could be used for obtaining the target channel coefficients by linear transformation on top of the measured channel coefficients of the associated reference signal.
   The procedure of using measured channel coefficients on the pilot positions to obtain the target channel coefficients expressed as ŷ=W_{aug}·y, where
      y∈ [symbol] ^{r}^{_{aug}}^{×1} represents the vector containing the measured channel coefficient on the pilot positions indicated by gNB;
      ŷ∈ [symbol] ^{s×1} represents the vector containing the target channel coefficients, which is obtained using the assistance information W_{aug} and y.
      It is well understood that the following relation exists: s≥r_{aug}≥r.
   The dimension of the target channel coefficients could be larger or equal to the dimension of the measured channel coefficients.
      If s>r_{aug}, then this procedure is called as channel interpolation;
      If s=r_{aug}, then this procedure is called as channel estimation or channel filtering.
The associated reference signal could be
   CSI-RS. Then the training channel matrix H represents downlink raw channel;
   DMRS for PDSCH. Then the training channel matrix represents downlink equivalent channel (the channel with precoding);
The assisted information could be configured
   Per RS type. Then the row dimension of the training channel matrix H will at least include the specific antenna port.
      If the associated RS is CSI-RS, s can include all the CSI-RS Tx ports;
      If the associated RS is DM-RS for PDSCH, s can include all the DM-RS ports;
The assisted information could be configured
   Periodical. The assistance information will be exchanged between gNB and UE regularly according to the preset period (The period can be configured by RRC).
   Semi-persistent. The assistance information will be exchanged between gNB and UE regularly according to the preset period and the corresponding MAC control element (MAC CE).
   Aperiodic. The assistance information will be exchanged between gNB and UE according to the DCI signaling.
The assisted information could be
   Tx & Rx ports in time/frequency domain.
      If the associated RS is SRS, then the Tx ports refer to the transmit antenna port at UE side and the Rx ports refer to the receive antenna port at gNB side.
      If the associated RS is DM-RS for PUSCH/PUCCH, then Tx ports refer to the DM-RS antenna port for PUSCH/PUCCH and the Rx ports refer to the receive antenna port at gNB side.

### 9.2 the Technical Benefit(s)/Advantage(s) of Embodiment

The matrix based assisted information for channel estimation on top of the sparse RS for SRS and/or DM-RS for PUSCH could be used for obtaining the target channel coefficients by linear transformation on top of the measured channel coefficients of the associated reference signal. It can be theoretically guaranteed a high accuracy for channel estimation.

The methods herein are performed by a device or an apparatus, e.g. by a processor of the device or apparatus executing instructions stored in a memory. The instructions, when executed, cause the device or apparatus to perform the methods.

The various options and embodiments described herein may be combined in different permutations. Also, although the invention has been described with reference to specific features and embodiments thereof, various modifications and combinations can be made thereto without departing from the invention. The description and drawings above are, accordingly, to be regarded simply as an illustration of some embodiments of the invention, and are contemplated to cover any and all modifications, variations, combinations or equivalents.

### 6G System Structure

### 6G Basic Module Structure

One or more steps of the embodiment methods provided herein may be performed by corresponding units or modules, according to FIG. 25. FIG. 25 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.
[1] A non-exhaustive list of possible unit or possible configurable parameters or in some embodiments of a MIMO system include:
[2] Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

1. A method, comprising:
receiving reference signals;
performing channel estimation based on the reference signals to obtain first channel coefficients corresponding to a first channel; and
obtaining second channel coefficients corresponding to a second channel based on the first channel coefficients and assistance information, wherein the assistance information indicates a relationship between the first channel and the second channel.

2. The method according to claim 1, wherein the obtaining the second channel coefficients corresponding to the second channel based on the first channel coefficients and the assistance information comprises:
obtaining the second channel coefficients corresponding to the second channel by performing a linear transformation or a non-linear transformation on the first channel coefficients and the assistance information.

3. The method according to claim 1, wherein the assistance information comprises one or more of: matrix based information, vector based information, tensor based information, or manifold information.

4. The method according to claim 3,
wherein the assistance information is the matrix based information or the tensor based information, and the assistance information is determined based on one or more of: a first matrix or a second matrix, and
wherein the first matrix and the second matrix represent a channel space basis matrix, and a dimension of the first matrix is larger than a dimension of the second matrix.

5. The method according to claim 3, wherein the assistance information is the manifold information, and the assistance information is related to a vector of the first channel coefficients.

6. A method, comprising:
transmitting reference signals; and
transmitting assistance information, wherein the assistance information indicates a relationship between a first channel and a second channel, second channel coefficients corresponding to the second channel are determined based on first channel coefficients corresponding to the first channel and the assistance information, and the first channel coefficients are obtained based on channel estimation of the first channel with the reference signals.

7. The method according to claim 6, wherein the second channel coefficients are determined by performing a linear transformation or a non-linear transformation on the first channel coefficients and the assistance information.

8. The method according to claim 6, wherein the assistance information comprises one or more of: matrix based information, vector based information, tensor based information, or manifold information.

9. The method according to claim 8,
wherein the assistance information is the matrix based information or the tensor based information, and the assistance information is determined based on one or more of: a first matrix or a second matrix, and
wherein the first matrix and the second matrix represent a channel space basis matrix, and a dimension of the first matrix is larger than a dimension of the second matrix.

10. The method according to claim 8, wherein the assistance information is the manifold information, and the assistance information is related to a vector of the first channel coefficients.

11. An apparatus, comprising:
at least one processor coupled with at least one memory storing one or more instructions that are capable of being run on the at least one processor, and when the one or more instructions are run, the apparatus is enabled to perform:
receiving reference signals;
performing channel estimation based on the reference signals to obtain first channel coefficients corresponding to a first channel; and
obtaining second channel coefficients corresponding to a second channel based on the first channel coefficients and assistance information, wherein the assistance information indicates a relationship between the first channel and the second channel.

12. The apparatus of claim 11, wherein the obtaining the second channel coefficients corresponding to the second channel based on the first channel coefficients and the assistance information comprises:
obtaining the second channel coefficients corresponding to the second channel by performing a linear transformation or a non-linear transformation on the first channel coefficients and the assistance information.

13. The apparatus of claim 11, wherein the assistance information comprises one or more of:
matrix based information, vector based information, tensor based information, or manifold information.

14. The apparatus of claim 13,
wherein the assistance information is the matrix based information or the tensor based information, and the assistance information is determined based on one or more of: a first matrix or a second matrix, and
wherein the first matrix and the second matrix represent a channel space basis matrix, and a dimension of the first matrix is larger than a dimension of the second matrix.

15. The apparatus of claim 13, wherein the assistance information is the manifold information, and the assistance information is related to a vector of the first channel coefficients.

16. An apparatus, comprising:
at least one processor coupled with at least one memory storing one or more instructions that are capable of being run on the at least one processor, and when the one or more instructions are run, the apparatus is enabled to perform:
transmitting reference signals; and
transmitting assistance information, wherein the assistance information indicates a relationship between a first channel and a second channel, second channel coefficients corresponding to the second channel are determined based on first channel coefficients corresponding to the first channel and the assistance information, and the first channel coefficients are obtained based on channel estimation of the first channel with the reference signals.

17. The apparatus of claim 16, wherein the second channel coefficients are determined by performing a linear transformation or a non-linear transformation on the first channel coefficients and the assistance information.

18. The apparatus of claim 16, wherein the assistance information comprises one or more of:
matrix based information, vector based information, tensor based information, or manifold information.

19. The apparatus of claim 18,
wherein the assistance information is the matrix based information or the tensor based information, and the assistance information is determined based on one or more of: a first matrix or a second matrix, and
wherein the first matrix and the second matrix represent a channel space basis matrix, and a dimension of the first matrix is larger than a dimension of the second matrix.

20. The apparatus of claim 18, wherein the assistance information is the manifold information, and the assistance information is related to a vector of the first channel coefficients.
